(19) United States
(12) Patent Application Publication
(10) Pub. No.: US 2003/0056116 A1
(43) Pub. Date: Mar. 20, 2003

(54) Reporter

(76) Inventors: Nelson Waldo Bunker V, Dallas, TX (US); David Laizerovich, Dallas, TX (US); Eva Elizabeth Bunker, Dallas, TX (US); Joey Don Van Schuyver, Lucas, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/150,325

(22) Filed: May 16, 2002

Related U.S. Application Data
(63) Continuation-in-part of application No. 09/861,001, filed on May 18, 2001.

(51) Int. Cl. H04L 9/00

(52) U.S. Cl. 713/201

(57) ABSTRACT

To answer the security needs of the market, a preferred embodiment was developed. A preferred embodiment provides real-time network security vulnerability assessment tests, possibly complete with recommended security solutions. External vulnerability assessment tests can emulate hacker methodology in a safe way and enable study of a network for security openings, thereby gaining a true view of risk level without affecting customer operations. Because this assessment can be performed over the Internet, both domestic and worldwide corporations benefit. A preferred embodiment's physical subsystems combine to form a scalable holistic system that can be able to conduct tests for thousands of customers any place in the world. The security skills of experts can be embedded into a preferred embodiment systems and automated the test process to enable the security vulnerability test to be conducted on a continuous basis for multiple customers at the same time. A preferred embodiment can reduce the work time required for security practices of companies from three weeks to less than a day, as well as significantly increase their capacity. Component subsystems typically include a Database, Command Engine, Gateway, multiple Testers, Report Generator, and an RMCT.

### BACKGROUND OF THE INVENTION

1. Field of the Invention

The present application relates to a system and method for assessing vulnerability of networks or systems to cyber attack.

2. Description of Related Art

As the Internet emerges as an increasingly important medium for conducting commerce, corporate businesses can be being introduced to new levels of opportunity, prosperity . . . and risk. To take full advantage of the opportunities that electronic commerce has to offer, corporations will be increasingly relying on the Internet, Intranets and Extranets to maximize their capabilities. The Internet has become a driving force creating new opportunities for growth through new products and services, enabling greater speed to penetrate global markets, and increasing productivity to facilitate competition. However, embracing the Internet also means undergoing a fundamental shift from an environment where systems and networks have been closed and protected to an environment that can be open, accessible and by its very nature, at risk. The Internet is assumed to be unsecured; the people using the Internet are assumed to be untrustworthy.

The risks come from 30,000 hacker sites that teach any site visitors how to penetrate systems and freely share tools and expertise with anyone who is interested. The tools that are freely available on these sites can be software-packaged electronic attacks that take only minutes to download and require no special knowledge to use, but give the user the ability to attack networks and computers anywhere in the world. In fact, International Data Corporation has estimated that more than 100 million people have the skills to conduct cyber-attacks. Security experts realize that almost every individual online can be now a potential attacker. Currently, people using the tools tend to be individuals, corporations and governments that are using the information provided to steal corporate assets and information, to damage systems or to plant software inside systems or networks.

In addition to the growth of the number of people who can break in, there can be an ongoing explosion in the number of ways to break in. In the year 2000, 1090 new security vulnerabilities were discovered by hackers and security experts and posted on the Internet for anyone to use. Every vulnerability can be a potential way to bypass the security of a particular type of system. Vulnerabilities were discovered for a broad range of systems; and the more popular a system or computer, the more vulnerabilities were found. For example, installing some Microsoft products will actually install many features and functionalities that are not necessarily intended by the computer user, such as a web server, an e-mail server, indexing services, etc. A default install of Microsoft ISS4 would contain over 230 different vulnerabilities.

The pace of discovery in 2000, at an average of more than two new vulnerabilities per day, led to 100% growth in the number of new vulnerabilities from 1999. And well over 2000 new vulnerabilities were discovered in 2001, continuing an extraordinary rate of vulnerability growth. These factors have driven computer break-ins to become a daily news story and have created corporate losses in the hundreds of millions of dollars.

From a testing perspective, vulnerabilities can only be found in devices that are known to exist. Therefore, the ability to see all of the networks and systems that are reachable from the Internet is paramount to accurate security testing.

In response to the increased need for security, corporations have installed Intrusion Detection Systems (IDS) and Firewalls to protect their systems. These security devices attempt to prevent access by potential intruders. A side effect of these devices can be to also block vulnerability assessment software scanners, making them unreliable to the corporations who can be most concerned about security.

Blocking by security devices affects software scanners and all vulnerability assessments that come from a single location in two ways. First, all computers cannot be identified by the scanner. As only computers that are found can be analyzed for vulnerabilities, not all of the access points of the network can be checked for security holes. Secondly, the security device can block access in mid-process of analyzing a computer for vulnerabilities. This can result in only partial discovery of security holes. An administrator can correct all the reported vulnerabilities and believe that the computer is secure, when there remain additional problems that were unreported. Both of these scenarios result in misleading information that can actually increase the risk of corporations.

It is apparent that network vulnerability issues are of strategic importance to businesses and other entities connected to the Internet. The state of the art of network vulnerability testing and reporting test results successfully addresses many issues, but leaves other issues unresolved such as the creation of useful and accessible reporting formats, for example. There are many other unresolved issues, some of which will be explicitly mentioned herein and many of which will be apparent to one of ordinary skill in the art upon review of this application. The present invention successfully addresses those unresolved issues as described, as well as many more that will be apparent to one of ordinary skill in the art.

### BRIEF SUMMARY OF THE INVENTION

To answer the security needs of the market, a preferred embodiment was developed. A preferred embodiment provides real-time network security vulnerability assessment tests, possibly complete with recommended security solutions. External vulnerability assessment tests can emulate hacker methodology in a safe way and enable study of a network for security openings, thereby gaining a true view of risk level without affecting customer operations. This assessment can be performed over the Internet for domestic and worldwide corporations.

A preferred embodiment's physical subsystems combine to form a scalable holistic system that is able to conduct tests for thousands of customers any place in the world. The security skills of experts can be embedded into a preferred embodiment systems and incorporated into the test process to enable the security vulnerability test to be conducted on a continuous basis for multiple customers at the same time. A preferred embodiment can reduce the work time required for security practices of companies from three weeks to less than a day, as well as significantly increase their capacity. This can expand the market for network security testing by allowing small and mid-size companies to be able to afford proactive, continuous electronic risk management.

A preferred embodiment includes a Test Center and one or more Testers. The functionality of the Test Center can be divided into several subsystem components, possibly including a Database, a Command Engine, a Gateway, a Report Generator, an Early Warning Generator, and a Repository Master Copy Tester.

The Database warehouses raw information gathered from the customers systems and networks. The raw information can be refined for the Report Generator to produce different security reports for the customers. Periodically, for example, monthly, information can be collected on the customers for risk management and trending analyses. The reports can be provided in hard copy, encrypted e-mail, or HTML on a CD. The Database interfaces with the Command Engine, the Report Generator and the Early Warning Generator subsystems. Additional functions of the Database and other preferred embodiment subsystem modules can be described in more detail subsequently, herein.

The Command Engine can orchestrate hundreds of thousands of “basic tests” into a security vulnerability attack simulation and iteratively test the customer systems based on information collected. Every basic test can be an autonomous entity that is responsible for only one piece of the entire test conducted by multiple Testers in possibly multiple waves and orchestrated by the Command Engine. Mimicking hacker and security expert thought processes, the attack simulation can be modified automatically based on security obstacles discovered and the type of information collected from the customer's system and networks. Modifications to the testing occur real-time during the test and adjustments can be made to basic tests in response to the new information about the environment. In addition to using the collected data to modify the attack/test strategy, the Command Engine stores the raw test results in the Database for future use. The Command Engine interfaces with the Database and the Gateway.

The Gateway is the “traffic director” that passes test instructions from the Command Engine to the Testers. The Gateway receives from the Command Engine detailed instructions about the different basic tests that need to be conducted at any given time, and it passes the instructions to one or more Testers, in possibly different geographical locations, to be executed. The Gateway can be a single and limited point of interface from the Internet to the Test Center, with a straightforward design that enables it to secure the Test Center from the rest of the Internet. All information collected from the Testers by the Gateway can be passed to the Command Engine.

The Testers can reside on the Internet, in a Web-hosted environment, and can be distributed geographically anyplace in the world. The entire test can be split up into tiny pieces, and it can also originate basic tests from multiple points and therefore be harder to detect and more realistic. The Testers house the arsenals of tools that can be used to conduct hundreds of thousands of hacker and security tests. The Tester can receive from the Gateway, via the Internet, basic test instructions that can be encrypted. The instructions inform the Tester which test to run, how to run it, what to collect from the customer system, etc. Every basic test can be an autonomous entity that can be responsible for only one piece of the entire test that can be conducted by multiple Testers in multiple waves from multiple locations. Each Tester can have many basic tests in operation simultaneously. The information collected by each test about the customer systems is sent to the Gateway and from there to the Database to contribute to creation of a customer's system network configuration.

The Report Generator can use the detailed information collected about a customer's systems to generate reports about the customer's system profile, Internet Address Utilization, publicly offered (i.e., open) services (e.g., web, mail, ftp, etc.), version information of installed services and operating systems, detailed security vulnerabilities, Network Topology Mapping, inventory of Firewall/Filtering Rule sets, publicly available company information such as usernames, e-mail addresses, computer names, etc. The types of reports can be varied to reflect the particular security services purchased by the customer. The report can be created based on the type of information the customer orders and can be delivered by the appropriate method and at the frequency requested.

New vulnerabilities can be announced on a daily basis. So many, in fact, it can be very difficult for the typical network administrator to keep abreast of relevant security news. Bugtraq, a popular mailing list for announcements, has often received over 350 messages a day. Thus, a network administrator using that resource, for example, may need to review a tremendous number of such messages in order to uncover two or three pertinent warnings relevant to his network. Then each machine on his network can need to be investigated in order to determine which can be affected or threatened. After the fix or patch can be installed, each machine can need to be re-examined in order to insure that the vulnerability can be truly fixed. This process can need to be repeated for each mailing list or resource similar to Bugtraq that the administrator can subscribe to.

When a new security vulnerability is announced on a resource like Bugtraq, the information can be added to the Vulnerability Library. Each vulnerability can be known to affect specific types of systems or specific versions of applications. The Vulnerability Library enables each vulnerability to be classified and cataloged. Entries in the Vulnerability Library might include, for example, vulnerability designation, vendor, product, version of product, protocol, vulnerable port, etc. Classification includes designating the severity of the vulnerability, while cataloging includes relating the vulnerability to the affected system(s) and/or application(s). The configuration of the new vulnerability can be compared to the customer's system network configuration compiled in the last test for the customer. If the new vulnerability is found to affect the customer systems or networks then a possibly detailed alert can be sent to the customer. The alert indicates which new vulnerability threatens the customer's network, possibly indicating specifically which machines can be affected and what to do in order to correct the problem. Then, depending on the customer profile, after corrective measures are taken, the administrator can immediately use the system to verify the corrective measures in place or effectiveness of the corrective measures can be verified with the next scheduled security assessment.

Only customers affected by the new security vulnerabilities can receive the alerts. The Early Warning Generator system filters the overload of information to provide accurate, relevant information to network administrators. Additionally, the known configuration of the customer can be updated every time a security vulnerability assessment can be performed, making it more likely that the alerts remain as accurate and relevant as possible.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIG. 1 depicts a diagram of an overview of a network vulnerability assessment system, in accordance with a preferred embodiment of the present invention;

FIG. 2 shows a block diagram of a Database logical structure, in accordance with a preferred embodiment of the present invention;

FIG. 3 depicts a block diagram of a Command Engine, in accordance with a preferred embodiment of the present invention;

FIG. 4 depicts a block diagram of a Gateway, in accordance with a preferred embodiment of the present invention.

FIG. 5 depicts a block diagram of a Tester structure, in accordance with a preferred embodiment of the present invention.

FIG. 6 depicts a block diagram of a Report Generator, in accordance with a preferred embodiment of the present invention.

FIG. 7 depicts a block diagram of a Early Warning Generator, in accordance with a preferred embodiment of the present invention.

FIG. 8 depicts a diagram of an overview of a network vulnerability assessment system adapted to update tools using a Repository Master Copy Tester (RMCT), in accordance with a preferred embodiment of the present invention.

FIG. 9 depicts a diagram of an overview of an internationally disposed network vulnerability assessment system adapted to update tools using a RMCT, in accordance with a preferred embodiment of the present invention.

FIG. 10 depicts a diagram of a distributed test, in accordance with a preferred embodiment of the present invention.

FIG. 11 depicts a diagram of a Frontal Assault test, in accordance with a preferred embodiment of the present invention.

FIG. 12 depicts a diagram of a Guerrilla Warfare test, in accordance with a preferred embodiment of the present invention.

FIG. 13 depicts a diagram of a Winds of Time test, in accordance with a preferred embodiment of the present invention.

FIG. 14 depicts a flowchart illustrating dynamic logic in testing, in accordance with a preferred embodiment of the present invention.

FIG. 15 depicts a flowchart illustrating one type of PRIOR ART logic in testing, in accordance with one embodiment of the PRIOR ART.

FIG. 16a depicts a diagram illustrating results from one method of PRIOR ART testing on a high security network, in accordance with one embodiment of the PRIOR ART.

FIG. 16b depicts a diagram illustrating results from using a preferred embodiment on a high security network, in accordance with a preferred embodiment of the present invention.

FIG. 17 depicts a diagram of an alternative preferred embodiment in which the functionalities of the database and command engine are performed by the same machine, in accordance with a preferred embodiment of the present invention.

FIG. 18 depicts a diagram of an alternative preferred embodiment in which requests for testing pass through third party portals, in accordance with a preferred embodiment of the present invention.

FIG. 19 depicts a diagram of a geographic overview of a network vulnerability assessment system testing target system with tests originating from different geographic locations in North America, in accordance with a preferred embodiment of the present invention.

FIG. 20 depicts a diagram of a geographic overview of a network vulnerability assessment system testing target system with tests originating from different geographic locations world-wide, in accordance with a preferred embodiment of the present invention.

FIG. 21 depicts a diagram of a logical conception of the relationship between a hacker tool and an application programming interface (API) wrapper, in accordance with a preferred embodiment of the present invention.

FIG. 22 depicts a flow chart of information within a database component of a network vulnerability assessment system, in accordance with a preferred embodiment of the present invention.

FIG. 23 depicts a flow chart of the testing process of a network vulnerability assessment system, in accordance with a preferred embodiment of the present invention.

FIG. 24 depicts a vulnerability trend graph, in accordance with a preferred embodiment of the present invention.

FIG. 25 depicts a vulnerability trend risk level graph, in accordance with a preferred embodiment of the present invention.

FIG. 26 depicts a vulnerability risk level graph, in accordance with a preferred embodiment of the present invention.

FIG. 27 depicts a root cause of current vulnerabilities graph, in accordance with a preferred embodiment of the present invention.

FIG. 28 depicts a graph of impacts of current vulnerabilities, in accordance with a preferred embodiment of the present invention.

FIG. 29 depicts a skill level to exploit current vulnerabilities graph, in accordance with a preferred embodiment of the present invention.

FIG. 30 depicts a sample report page of vulnerabilities by risk in a Host Detail report, in accordance with a preferred embodiment of the present invention.

FIG. 31 depicts a sample report page of potential vulnerabilities warnings in a Host Detail report, in accordance with a preferred embodiment of the present invention.

FIG. 32 depicts a sample report page of host information contained in a Technical Summary report, in accordance with a preferred embodiment of the present invention.

FIG. 33 depicts a sample report page of vulnerabilities by risk in a Standard Report, in accordance with a preferred embodiment of the present invention.

FIG. 34 depicts a sample report page of warnings of potential vulnerabilities in a Standard Report, in accordance with a preferred embodiment of the present invention.

FIG. 35 depicts a sample report page of vulnerabilities by host in a Standard Report, in accordance with a preferred embodiment of the present invention.

FIG. 36 depicts a sample report page of detailed profile information in a Standard Report, in accordance with a preferred embodiment of the present invention.

FIG. 37 depicts a sample report page of a listing of services on a network in a Standard Report, in accordance with a preferred embodiment of the present invention.

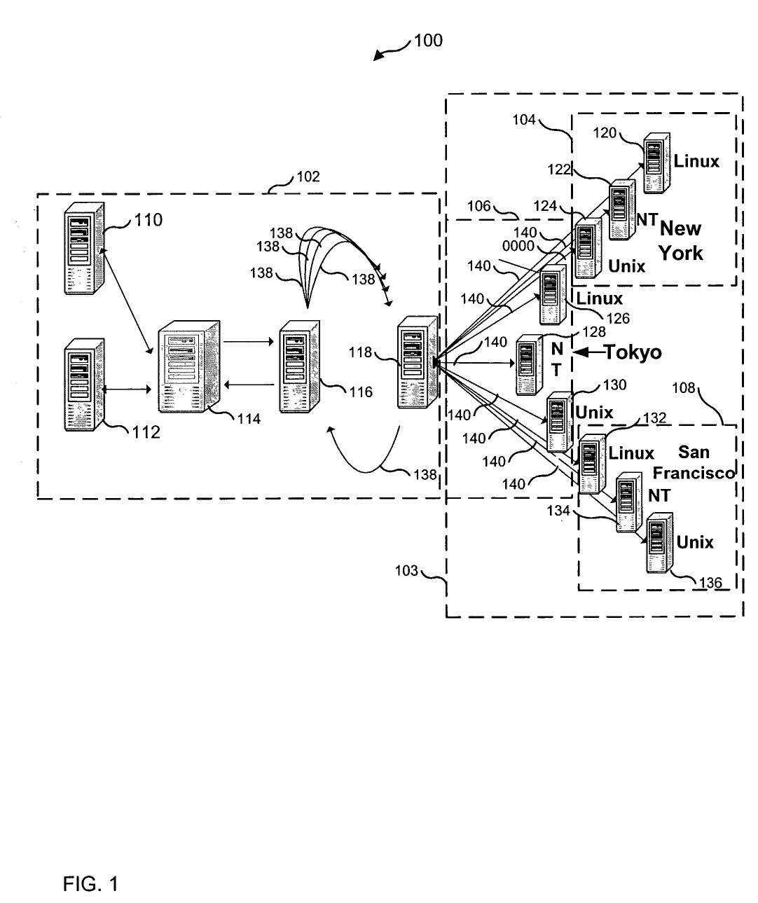

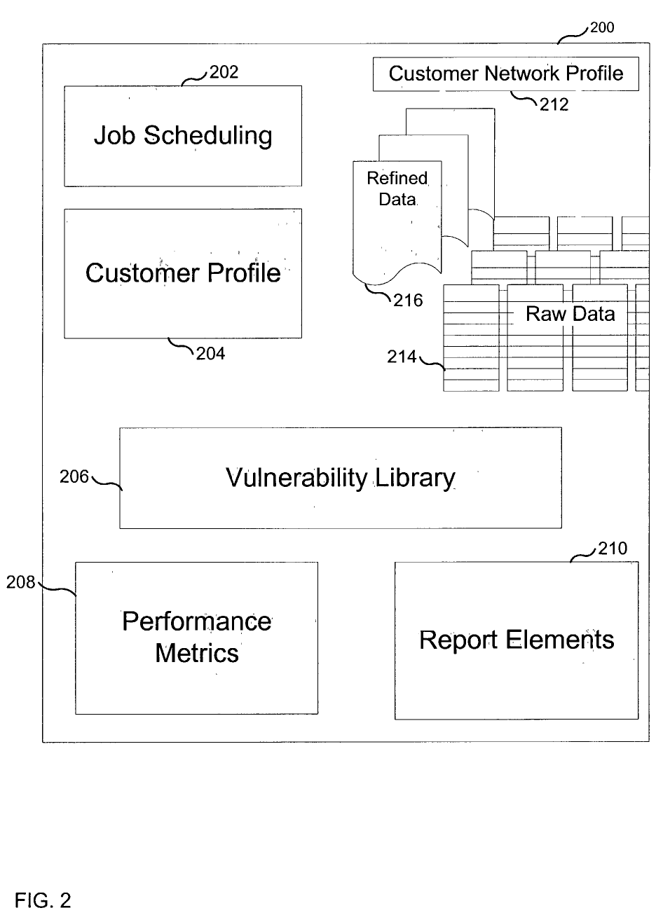

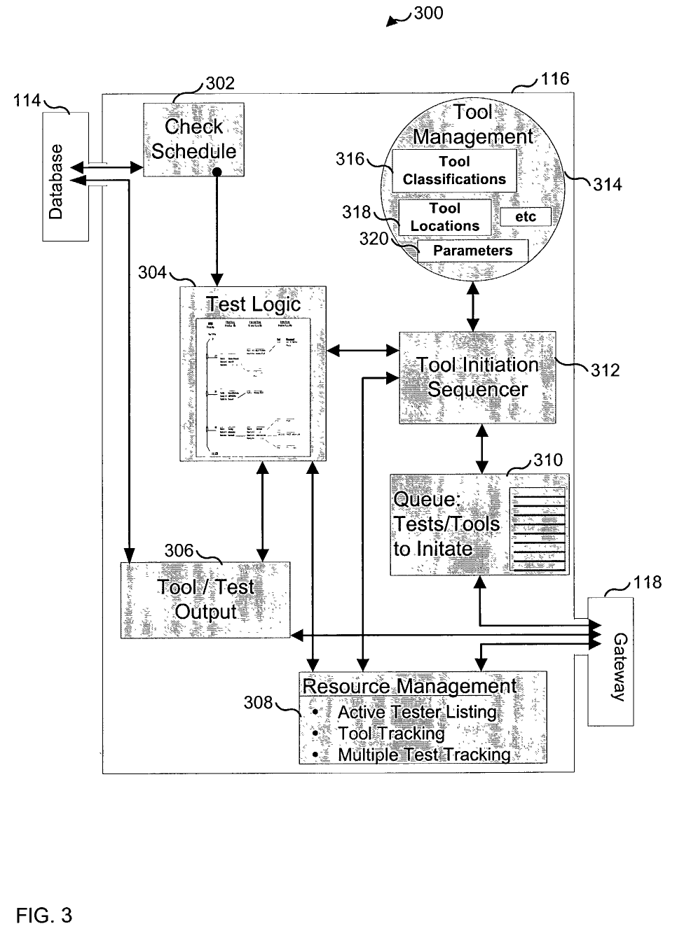

### DETAILED DESCRIPTION OF PREFERRED EMBODIMENTS

The numerous innovative teachings of the present application will be described with particular reference to the presently preferred embodiment (by way of example, and not of limitation). Referring now to the drawings, wherein like reference numbers are used to designate like elements throughout the various views, several embodiments of the present invention are further described. The FIGS. are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

Successful management of network vulnerabilities is promoted by discovery of vulnerabilities, an up-to-date arsenal of testing tools, a good library of report modules associated with vulnerabilities, generation of useful accessible reports, etc. Outsourcing some or all of this functionality can save a company 2-5 or more in house technical people.

Database Subsystem Functionality

The Database 114 has multiple software modules and storage facilities 200 for performing different functions. The Database warehouses the raw data 214 collected by the Testers' 502 tests 516 from customers systems and networks 1002 and that data can be used by the Report Generator 112 to produce different security reports 2230 for the customers. The raw data 214 contained in the Database 114 can be migrated to any data format desired, for example, by using ODBC to migrate to Oracle or Sybase. The type of data might include, for example, IP addresses, components, functions, etc. The raw data 214 can typically be fragmented and cannot be easily understood until decoded by the Report Generator 110.

The brand of database 114 is unimportant and the entire schema was designed to port to any database. A preferred embodiment uses Microsoft SQL server, because of availability of the software and experience in developing in SQL Server. Logical overview 200 shows a logical view of Database 114.

Job Scheduling

The job scheduling module 202 can initiate customer jobs at any time. It uses the customer profile 204 information to tell the Command Engine 116 what services the customer should receive, for example, due to having been purchased, so that the Command Engine 116 can conduct the appropriate range of tests 516.

Customer Profile

Every customer has a customer profile 204 that can include description of the services the customer will be provided, the range of IP addresses the customer's network 1002 spans, who should receive the monthly reports, company mailing address, etc. The customer profile 204 can be used by the Command Engine 114 to conduct an appropriate set of tests 516 on the customer's systems 1002. The customer profile 204 can be also used by the Report Generator 110 to generate appropriate reports 2230 and send them to the appropriate destination. Customer Profile information includes that information discussed in this specification which would typically be provided by the Customer, such as IP addresses, services to be provided, etc. In contrast, Customer Network Profile information includes that information which is the result of testing.

Vulnerability Library

The Vulnerability Library 206 catalogs all the vulnerabilities that a preferred embodiment tests for. This library 206 can be used by the Report Generator 110 to tell the customers what security vulnerabilities they have. The data associated with each vulnerability can also indicate the classification of the vulnerability as to its severity. Severity has several aspects, for example, risk of the vulnerability being exploited can be high, medium, or low; skill level to exploit the vulnerability can be high, medium, or low; and the cause of the vulnerability can be vendor (for example, bugs), misconfiguration, or an inherently dangerous service.

Performance Metrics

Different types of performance metrics 208 can be stored for each test. Reasons that the system stores performance metrics 208 include, for example, in order to be able to plan for future scaling of the system and to track the durations and efficiency levels of the tests 516. Performance metrics 208 allow determination, for example, of when system capacity can be expected to be reached and when more Testers 502 can be expected to be needed added to Tester array 103 to maintain adequate performance capacity.

The ability to perform performance metrics 208 comes from two places: (1) utilizing standard network utilities and methodologies, and (2) analysis of database 114 information. More sources of the ability to perform performance metrics 208 will become available over time. Current performance metrics 208 include, job completion timing, which is (1) time to complete an overall assessment (can be compared with type of assessment as well as size of job); (2) time to complete each Tool Suite 9 e.g., HTTP Suite 2318); (3) time to complete each wave of tests 516; and (3) time to complete each test 516. Also, assessment time per IP address/active nodes assessment time per type of service active on the machine. Tester 502 performance metrics 208 include, for example, resources available/used, memory, disk space,- and processor. Gateway 118 performances metrics 208 include, for example, resources available/used, memory, disk space, and processor. Other performance metrics 208 include, for example, communication time between Tester 502 and Gateway 118 (latency), communication time between Gateway 118 and Tester 502 (network paths are generally different), and bandwidth available between Tester 502 and Gateway 118. Future performance metrics might include, Tester 502 usage, by operating system, by Network (Sprint, MCI, etc.), IP address on each Tester 502; test 516 effectiveness by operating system, by Network, by Tester 502; and Gateway 118/Distribution of tests across Testers 103.

Report Elements

Report Elements 210 are used to build reports 2230. The Report Elements 210 area of the Database 114 can hold these report elements 210 at their smallest resolution. The Report Generator 110 subsystem accesses the report elements 210 to create a customer vulnerability assessment report 2230. The Report Generator 110 reads the test results of a vulnerability assessment from the Database 114 and can use the test results to organize the Report Elements 210 into a full, customized report 2230 for the customer. All of the raw data 214 as well as the refined data 216 about a customer network 1002 can be stored in the Database 114 in a normalized secure form which is fragmented and has no meaning until the Report Generator 110 decodes the data and attaches a Report Element 210 to each piece of information. The Report Elements 210 enable the reports 2230 to contain meaningful, de-normalized information and allow the Database 114 to maintain the original data in a manageable format.

Some Report Elements 210 can be the same as, directly based on, or indirectly based on information from Vulnerability Library 206.

The Report Elements 210 typically compose a very large set of text records which can make up all possible text passages that can eventually appear in a report 2230.

Customer's Network Profile, Raw Data, and Refined Data

All data collected by the basic tests can be stored in their raw form 214 on an ongoing basis. The data can be used by the Report Generator 110 and by data mining tools. The Report Generator 110 can use this data to provide historical security trending, detailed analysis and current vulnerability assessment reports 2230. Data mining can provide security trend analysis across varying network sizes and industries. Other data mining opportunities can present themselves as the number of customers grows. The Early Warning Generator 112 can reference the most recent information about a customer network 1002 in order to alert only threatened customers about the newest relevant security vulnerabilities found.

Report 2230 metrics can also be used to classify test results for different market segments and industries to be able to calcify risk boundaries. For example, this would enable an insurer to change insurance rates based on risk metrics indicators.

In addition, the raw information 214 can be used by experienced security consultants to give themselves the same intimate familiarity with the customer's network 1002 that they would normally gain during a manual test 516 but without actually having to perform the tests 516 themselves. This can allow security personnel to leverage their time more efficiently while maintaining quality relationships with customers.

Command Engine Subsystem Functionality

Figuratively, the Command Engine 116 is the “brain” that orchestrates all of the “basic tests” 516 into the security vulnerability attack simulation used to test the security of customer systems and networks 1002. While the Command Engine 116 essentially mimics hackers, the tests 516 themselves should be harmless to the customer. Each basic test 516 can be a minute piece of the entire test that can be launched independently of any other basic test 516. The attack simulation can be conducted in waves, with each wave of basic tests 516 gathering increasingly fine-grained information. The entire test can be customized to each customer's particular system 1002 through automatic modifications to the waves of basic tests 516. These modifications occur in real-time during the actual test in response to information collected from the customer's systems and networks 1002. For example, the information can include security obstacles and system environment information. The Command Engine 116 stores the raw test results 214 in the Database 114 for future use as well as uses the collected data to modify the attack/test strategy. This test process is iterative until all relevant customer data can be collected. Note that there is no reason why the functions of the Command Engine 116 could not be performed by and incorporated into the Database 114 in an alternative embodiment. Such a device, combining Database 114 and Command Engine 116 functions might be called a Command Database 1702.

Check Schedule

The Check Schedule module 302 polls the Job Scheduling module 202 to determine whether a new test 516 needs to be conducted. The Check Schedule module 302 then passes the customer profile information 204 for the new tests 516 to the Test Logic module 304.

Test Logic

The following discussion describes a multiple wave entire test. The Test Logic module 304 receives the customer profile information 204 from the Check Schedule module 302. Based on the customer profile 204, the Test Logic module 304 determines which basic tests 516 need to be launched in the first wave of testing and from which Testers 502 the basic tests 516 should come. The Test Logic module 304 uses the customer profile 204 to assemble a list of specific tests 516; the Test Logic module 304 uses the Resource Management module 308, which tracks the availability of resources, to assign the tests to specific Testers 502. As the basic tests 516 are determined, they are passed with instructions to the Tool Initiation Sequencer 312 where all of the tool 514 details and instructions are combined. Each sequence of basic test instructions proceeds from the Tool Sequencer 312 to the Queue 310 as an instruction for a specific Tester 502 to run a specific test 516. There is no reason why the Resource Management module 308 could not be part of Gateway 118 because such an alternative would be an example of the many alternatives that would not vary substantially from what has been described. Similarly, throughout this specification, descriptions of functionalities being in certain physical and/or logical orientations (e.g., being on certain machines, etc.), should not be considered as limitations, but rather as alternatives, to the extent that other alternatives of physical and/or logical orientations would not cause inoperability.

As the results of the basic tests 516 return 306, the Test Logic module 304 analyzes the information and, based on the information discovered, determines which basic tests 516 should be performed in the next wave of basic tests 516. Again, once the appropriate tests 516 have been determined, they are sent to the Tool Initiation Sequencer 312 where they enter the testing cycle.

Each wave of basic tests 516 becomes increasingly specific and fine-grained as more is learned about the environment 1002 being tested. This dynamic iterative process repeats and adapts itself to the customer's security obstacles, system configuration and size. The process ends when all relevant information has been collected about the customer system 1002.

Tool Management

The Tool Management module 314 manages all relevant information about the tools 514, possibly including classification 316, current release version, operating system dependencies, specific location 318 inside the Testers 502, test variations of tools, and all parameters 320 associated with the test. Because there can be thousands of permutations of testing available for each tool 514, the Test Logic module and the Initiation Sequencer 312 are data driven processes. The Tool Management 314, in conjunction with the Test Logic module 304, and the Initiation Sequencer 312 supplies the necessary detailed instructions to perform the basic tests 516. Tools 514 can be classified according to operating system or any other criterion or criteria. If a vulnerability becomes apparent for which no tool 514 currently exists, then a new tool 514 can be written in any language and for any operating system that will test for that vulnerability. The new tool 514 might then be referred to as a proprietary tool.

Tool Initiation Sequencer

The Tool Initiation Sequencer 312 works in conjunction with the Test Logic module 304 and the Tool Management module 314. It receives each sequence of instructions to run a specific basic test 516 from the Test Logic module 304. This information can be then used to access the Tool Management module 314 where additional information, such as tool location 318 and necessary parameters 320, can be gathered. The Tool Initiation Sequencer 312 then packages all relevant information in a standardized format. The formatted relevant information includes the detailed instructions that can be put in the Queue 310 to be polled by the Gateway 118 or pushed to the Gateway 118.

Queue of Test Tools

The Queue 310 is a mechanism that allows the Gateway 118 to poll for pending instructions to pass on to the Testers 502. The instructions for each basic test 516 can be stored as a separate order, and instructions for basic tests 516 belonging to multiple customer tests can be intermingled in the Queue 310 freely.

Tools Test Output

The results of each basic test 516 are returned from the Testers 502 to the Command Engine's 116 Tool/Test Output module 306. This module 306 transfers the test results to two locations. The information can be delivered to the Database 114 for future report generation use and recycled through the Test Logic module 304 in order to be available to adapt a subsequent wave of tests 516.

Resource Management

The Resource Management module 308 manages Tester 502 availability, Internet route availability, basic test 516 tracking, and multiple job tracking for entire tests being performed for multiple customer networks 1002 simultaneously. Tracking the availability of Testers 502 and Internet routes enables the testing to be performed using the most efficient means. Basic test 516 and job test tracking can be used to monitor for load on Testers 502 as well as the timeliness of overall jobs. The information used to manage resources can be gained from the Gateway 118 and from the Testers 502, via the Gateway 118.

Resource management information can be provided to the Test Logic module 304 and the Tool Initiation Sequencer 312. If a Tester 502 becomes unavailable, this information can be taken into account and the Tester 502 is not used until it becomes available again. The same can be true for periods of Internet route unavailability. Current basic tests 516 that relied on the unavailable resources would be re-assigned, and new basic tests 516 would not be assigned to resources that are unavailable.

The Gateway Subsystem Functionality

Functionally, the Gateway 118 can be partly characterized as the “traffic director” of a preferred embodiment. While the Command Engine 116 acts in part as the “brain” that coordinates the use of multiple tests 516 over multiple Testers 502, it is the Gateway 118 that interprets the instructions and communicates the directions (instructions) to all of the Testers 502. The Gateway 118 receives from the Command Engine 116 detailed instructions about basic tests 516 that need to be conducted at any given time, and it passes the instructions to appropriate Testers 502, in appropriate geographical locations, to be executed. The Gateway 118 can be a single and limited point of interface from the Internet to the Test Center 102, with a straightforward design that enables it to secure the Test Center 102 from the rest of the Internet. All information collected from the Testers 502 by the Gateway 118 can be passed to the Command Engine 116.

The Gateway 118 receives basic test 516 instructions from the Command Engine Queue 310 and sends these instructions to the appropriate Testers 502. The instruction sequence consists of two parts. The first part contains instructions to the Gateway 118 indicating which Tester 502 the Gateway 118 should communicate with. The second part of the instructions is relevant to the Tester 502, and it is the second part of these instructions that are sent to the appropriate Tester 502.

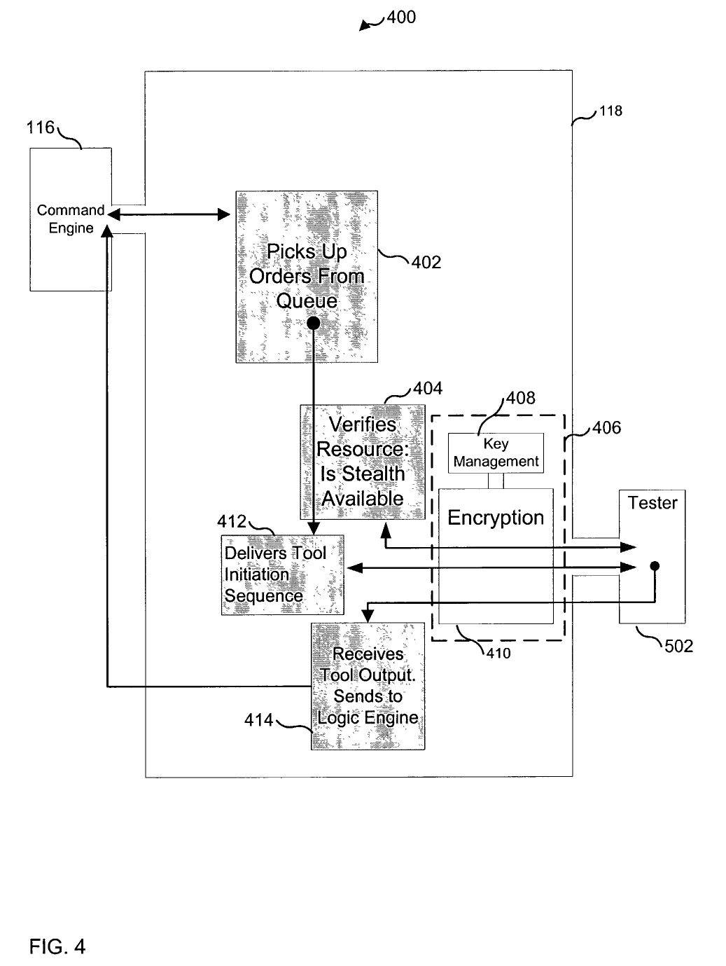

Prior to delivering the instructions to the Tester 502, the Gateway 118 verifies the availability of the Tester 502 and encrypts 406 the instruction transmission. In FIG. 4, encryption 406 uses key management 408 to achieve encryption 410, but other encryption techniques would not change the spirit of the embodiment. If communication cannot be established with the Tester 502, then the Gateway 118 runs network diagnostics to determine whether communication can be established. If communication can be established 404, then the process continues, otherwise, the Gateway 118 sends a message to the Command Engine Resource Management 308 that the Tester 502 is “unavailable”. If the Gateway 118 is able to send 412 test instructions to the Tester 502, it does so. After the Tester 502 runs its basic test 516, it sends to the Gateway 118 the results 414 of the basic test 516 from the Tester 502 and relays the information 414 back to the Command Engine 116. The Gateway 118, as “traffic director”, enables a set of tests 516 to be conducted by multiple Testers 502 and multiple tests 516 to be run by one Tester 502 all at the same time. This type of security vulnerability assessment is typically hard to detect, appears realistic to the security system, and can reduce the likelihood of the customer security system discovering that it is being penetrated.

An alternative to the test instruction push paradigm that has been described thus far is a test instruction pull paradigm. The pull approach is useful where the customer simply refuses to lower an unassailable defense. The Tester 502 would be placed within the customer's system 1002, beyond the unassailable defense, and would conduct its tests from that position. Rather than the sending of instructions from the Gateway 118 to the Tester 502 being initiated by the Gateway 118, the Tester 502 would repeatedly poll the Gateway 118 for instructions. If the Gateway 118 had instructions in its queue 402 ready for that Tester 502, then those instructions would be transmitted responsively to the poll.

The Tester Subsystem Functionality

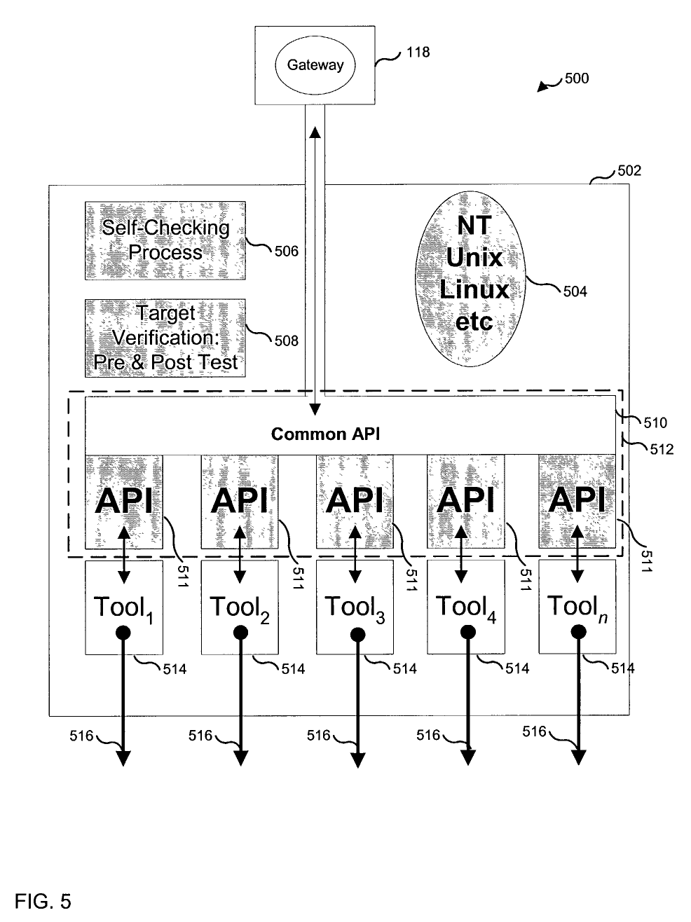

Depicted in overview 500, FIG. 5, the Testers 502 can reside on the Internet, in a Web-hosted environment, or on customers' networks 1002, and can be distributed geographically around the world. Not only can the entire test be split up into tiny pieces, but it can also originate each piece from an independent point and is therefore harder to detect and more realistic. Even entire tests conducted monthly on the same customer can come from different Testers 502 located in different geographical areas.

The Testers 502 house the arsenals of tools 514 that can conduct hundreds of thousands of hacker and security tests 516. The Tester 502 can receive encrypted basic test instructions from the Gateway 118, via the Internet. The instructions inform the Tester 502 which test 516 to run, how to run it, what to collect from the customer system, etc. Every basic test 516 can be an autonomous entity that can be responsible for only one piece of the entire test that can be conducted by multiple Testers 502 in multiple waves from multiple locations. Each Tester 502 can have many basic tests 516 in operation simultaneously. The information collected by each test 516 about the customer systems 1002 can be sent to the Gateway 118.

Following is a partial list of hacker tools 514 that a preferred embodiment is adapted to use: (a) CGI-scanners such as whisker, cgichk, mesalla; (b) port scanners—nmap, udpscan, netcat; (c) administrative tools—ping, traceroute, Slayer ICMP; (d) common utilities—samba's nmblookup, smbclient; and (e) Nessus program for assessing a computer's registry.

The Testers 502 are independent entities working in concert, orchestrated by the Command Engine 116. Because they can be independent entities, they do not need to have the same operating systems 504. Utilizing various operating systems 504 can be an advantage in security vulnerability assessment, and assists a preferred embodiment in maximizing the strengths of all the platforms. This typically leads to more accurate assessments and more efficient operations.

Following are three examples of actual information returned by tools 514. The first tool 514 is Nmap port scanner, running in one of its variations:

Starting nmap V.2.53 by fyodor@insecure.org (www.insecure.org/nmap/)

Interesting ports on localhost (127.0.0.1):

(The 1502 ports scanned but not shown below are in state: closed)

| Port | State | Service |
|---|---|---|
| 1/tcp | open | tcpmux |
| 11/tcp | open | systat |
| 15/tcp | open | netstat |
| 21/tcp | open | ftp |
| 22/tcp | open | ssh |
| 23/tcp | open | telnet |
| 25/tcp | open | smtp |
| 53/tcp | open | domain |
| 79/tcp | open | finger |
| 80/tcp | open | http |
| 635/tcp | open | unknown |
| 1080/tcp | open | socks |
| 8/tcp | open | squid-http |
| 12345/tcp | open | NetBus |
| 12346/tcp | open | NetBus |
| 31337/tcp | open | Elite |

Nmap run completed—1 IP address (1 host up) scanned in 2 seconds.

The second tool 514 is whisker—web cgi script scanner:

—whisker/v1.4.0+SSL/rainforestpuppy/www.wiretrip.net—

—(Bonus: Parallel support)

= = = = = =

=Host: 127.0.0.1

—Server: Microsoft-IIS/4.0

+200 OK: HEAD/vti inf.html

+200 OK: HEAD/private/form results.txt

The third tool 514 is icmp query for remote time stamp and remote subnet of a computer:

#./icmpquery-t 127.0.0.1

127.0.0.1:17:17:33

127.0.0.1: OxFFFFFFE0

Inside each Tester 502 can be storehouses, or arsenals, of independent hacker and security tools 514. These tools 502 can come from any source, ranging from pre-made hacker tools 514 to proprietary tools 514 from a development team. Because the Testers 502 can be NT, Unix, Linux, etc 504, the tools 514 can be used in their native environment using an application programming interface (API) 512, described elsewhere in this specification, with no need to rewrite the tools 514. This usage gives a preferred embodiment an advantage in production. For example, hacker tools 514 that are threatening corporations everywhere can be integrated into a preferred embodiment the same day they are published on the Internet. The API 512 also serves to limit the quality control testing cycle by isolating the new addition as an independent entity that is scrutinized individually. Additionally, because tools 514 can be written in any language for any platform 504, the development of proprietary tools 514 need not be dependent on a lengthy training cycle and might even be outsourced. This ability is a significant differentiator for a preferred embodiment.

Running the tools 514 from a separate tool server would be possible using a remote mount.

The API 512 handles the things that are common among all the tools 514 that we have on a Tester 502. Typically each tool wrapper will have commonly named variables that have specifics about the particular tool wrapper. The API 512 will use these variable values to do specific, common functionality, such as “open a file to dump tool results into”. In that example, the wrapper would simply call API::OpenLogFile. At this point the API 512 would be invoked. In that example, the API 512 will look at the values of the variables from the main program that called it. These variables will have the specifics of the particular wrapper. The API 512 will then open a log file in the appropriate directory for the program to write to. For example, the commands:

$Suite=‘http’;

$Tool=‘cgiscan’;

would produce something similar to the following:

/var/achilles/http/cgiscan/scanlog/J2334 T4234

Other common functionality can be handled by the API 512. For example when a tool 514 has completed and its information has been parsed, each wrapper can call the same function that initiates a connection back the Gateway 118 and deposits the parsed info on the Gateway 118 for pickup by the Command Engine 116. Example: The tool wrapper simply calls the function API::CommitToGateway (filename) and the API 512 is responsible for opening the connection and passing the info back to the Gateway 118, all with error handling.

Other functionality includes but is not limited to: retrieving information passed to the tool 514 via command line parameters (Job Tracking ID, Tool Tracking ID, Target Host IP Address, etc.); Opening, Closing, and Deleting files; Error/Debug Logging Capability; Character substitution routines; etc.

The system's capacity to conduct more tests for multiple customers at the same time can be increased dramatically by adding more Testers 502.

Internal Tester

Internal Tester machines 502 are for the vulnerability assessment of an internal network, DMZ, or other areas of the network 1002. The performance of an internal assessment can give a different view than just performing an external assessment. The resulting information can let an administrator know, if a cyber attacker were to perform an attack and gain access to network 1002, what other machines, networks or resources the attacker would have access to. In addition, internal assessments can be conducted with administrative privileges thereby facilitating audit of individual workstations for software licensing, weak file permissions, security patch levels, etc.

For the purposes of an internal assessment, several different appliances can be deployed on the customers network 1002. For example, for traveling consultants, a pre-configured laptop computer loaded with an instance of a Tester 502 might be shipped for deployment. For permanent, continuous assessment installations a dedicated, pre-configured device in either a thin, rack mountable form or desktop style tower might be shipped for deployment. In both cases the device might boot out-of-the-box to a simple, graphical, configuration editor. The editor's interface is a web browser that might point to the active web server on the local loop-back device. Since the web server would be running on the loop-back device, it could only be accessible by the local machine. Some options of local configurations might include, for example: IP Stack configuration, DNS information, default route table, push/pull connection to Test Center 102, account information, etc. Other options in the local configuration might include for example: IP diagnostics (Ping, Trace Route, etc.), DNS Resolutions, connections speed, hardware performance graphs, etc.

Once local configuration has been completed and the Tester 502 verified to be active on the local network with some form of connectivity to the Internet, the web browser then can switch from the local web to a remote web server of a preferred embodiment. At this point the specifications of the test might be entered. If this were a single assessment, the IP range, Internet domain name, package type and company information might be necessary. For a continuous/permanent installation, other options might include frequency, re-occurrence, etc. Minor updates might be performed via a preferred embodiment upgrade systems. Major upgrades might be initiated for example by the traveling consultant prior to going to the customer's site or, in the case of a permanent installation, remotely initiated during a scheduled down time.

The actual assessment might be similar to the remote assessment, however distributed capabilities would not be needed. Other future, add-on modules might include: registry readers for auditing of software licenses, modules for asserting file permissions, policy management modules, etc.

Defending the Tester

The use of a distributed architecture can mean placing out Testers 502 in hostile environment(s). Safeguards, policies, and methodologies should be in place to ensure the Integrity, Availability, and Confidentiality of the technology of a preferred embodiment.

While the internal mechanisms of the Testers 502 can be complex, the external appearance can be simple by contrast. Each Tester 502 can be assigned one or more IP addresses; however, it could be that only the primary IP address has services actually running on it. These minimal services can be integral to the Tester 502. The remaining IP addresses would have no services running on them. Having no services running means that there is no opportunity for an external attacker to gain access to the Tester 502. In addition, there are several processes that are designed to keep the environment clean of unknown or malicious activity.

Each Tester 502 can be pre-configured in-house and designed for remote administration. Therefore, it would typically be that no peripherals (e.g., keyboard, monitor, mouse, floppies, CD-ROM drives, etc.) are enabled while the Tester 502 is in the field. An exception might be an out-of-band, dial-up modem that might feature strong encryption for authentication, logging, and dial-back capabilities to limit unauthorized access. This modem could be used, for example, in emergencies when the operating system is not completing its boot strap and could be audited on a continuous basis. This could limit the need for “remote-hands” (e.g., ISP employees) to have system passwords, and would reduce the likelihood of needing a lengthy on-site trip. Other physical security methods, such as locked computer cases, can be implemented. One example might be a locked case that would, upon unauthorized entry, shock the hardware and render the components useless.

Until the integrity of Tester 502 can be verified by an outside source, it would be the case that no communication with the device will be trusted and the device can be marked as suspect. Confidence in integrity can be improved by several means. First of all, Tester's 502 arsenals of tools 514, both proprietary and open source,-can be contained on encrypted file systems. An encrypted file system can be a “drive” that, while un-mounted, appears to be just a large encrypted file. In that case, when the correct password is supplied, the operating system would mount the file as a useable drive. The can prevent for example an unauthorized attacker with physical access to the Tester 502 from simply removing the drive, placing it into another machine and reading the contents. In that case, the only information an attacker might have access to might be the standard build of whatever operating system the Tester 502 happened to be running. If used, passwords can be random, unique to each Tester 502, and held in the Test Center 102. They can be changed from time to time, for example, on a bi-weekly basis.

To protect the contents of the operating system itself, the contents can be verified before placing the Tester 502 in operation. For example, using a database of cryptographically calculated checksums the integrity of the system can be verified. Using that methodology, the “last known good” checksum databases can be held offsite and away from the suspected machine. Also, tools to calculate these sums can not stored on the machine because they might then be altered by a malicious attacker to give a false positive of the integrity of the suspected Tester 502.

Upon boot, the Tester 502 can send a simple alert to the Gateway 118 indicating it is online. The Gateway 118 can then issue a process to verify the integrity of the operating system. The process can connect to the Tester 502, upload the crypto-libraries and binaries, perform the analysis, and retrieve the results. Then the crypto-database can be compared to the “Last Good” results and either approve or reject the Tester 502. Upon rejection the administrator on call can be notified for manual inspection. Upon approval, the process can retrieve the file system password and use an encrypted channel to mount the drive. At this point the Tester 502 can be considered an extension of the “Test Center 102” and ready to accept jobs. This verification process can also be scheduled for pseudo-random spot checks.

Security typically requires vigilance. Several processes can be in place to improve awareness of malicious activity that is targeting an embodiment of the invention. Port Sentries and Log Sentries can be in place to watch and alert of any suspicious activity and as a host-based intrusion detection system. Port Sentry is a simple, elegant, open source, public domain tool that is designed to alert administrators to unsolicited probes. Port sentry opens up several selected ports and waits for someone to connect. Typical choices of ports to open are services that are typically targeted by malicious attackers (e.g., ftp, sunRPC, Web, etc.). Upon connection, the program can do a variety of different things: drop route of the attacker to /dev/nul; add attacker to explicit deny list of host firewall; display a strong, legal warning; or run a custom retaliatory program. As such a strong response could lead to a denial of service issue with a valid customer, an alternative is to simply use it to log the attempt to the Tester 502 logs. Log sentry is another open source program that can be utilized for consolidation of log activity. It can check the logs every five minutes and e-mail the results to the appropriate internet address.

There is no control over e-mail once it leaves the internal network, e-mail can be read, tampered with and spoofed. All e-mails from the Tester 502 can be encrypted, for example, with a public key before transport that improves the likelihood that it can only be read by authorized entities.

Any username and password combination is susceptible to compromise, so an alternative is to not use passwords. An option is that only the administrator account has a password and that account can only be logged on locally (and not for example through the Internet) via physical access or the out-of-band modem. In this scenario, all other accounts have no passwords. Access would be controlled by means of public/private key technology that provides identification, authentication, and non-reputability of the user.

To reduce the likelihood that data can be captured, all communication with the Testers 502 can be by way of an encrypted channel. Currently the module for communication can be Secure Shell (SSH1) for example. This could be easily switched to Open SSH, SSH2 or any other method. SSH provides multiple methods of encryption (DES, 3DES, IDEA, Blowfish) which is useful for locations where export of encryption is legally regulated. In addition, 2048 bit RSA encryption keys can be used for authentication methods. SSH protects against: IP spoofing, where a remote host sends out packets which pretend to come from another, trusted host; a “spoofer” on the local network, who can pretend he is your router to the outside; IP source routing, where a host can pretend that an IP packet comes from another, trusted host; DNS spoofing, when an attacker forges name server records; interception of clear text passwords and other data by intermediate hosts; and manipulation of data by people in control of intermediate hosts.

Self-Checking Process

Prior to accepting instructions to initiate a basic test 516, Testers 502 can undergo a Self-Checking Process 506 to verify that resources are available to perform the task, that the tool 514 exists in its arsenal, that the correct version of the tool 514 is installed, and that the security integrity of the Tester 502 has not been tampered with. This process 506 can take milliseconds to perform. Tester 502 resources that can be checked include memory usage, processor usage, and disk usage. If the tool 514 does not exist or is not the correct version, then the correct tool 514 and version can be retrieved by the Tester 502 from the RMCT 119, discussed elsewhere herein. Periodic testing can be conducted to confirm that the RMCT 119 retains its integrity and has not been tampered with.

Target Verification Pre and Post Test

Pre Test Target Verification 508 can used to detect when a Tester 502 cannot reach its targeted customer system 1102 in network 1002 due to Internet routing problems. Internet outages and routing problems can be reported back through the Gateway 118 to the Resource Management module 308 of the Command Engine 116, and the basic test 516 can be rerouted to another Tester 502 on a different Internet router.

Post Test Target Verification 508 can be used to detect if the Tester 502 has tripped a defensive mechanism that might prevent further tests from gathering information. This can be particularly useful for networks 1002 with a Firewall/Intrusion Detection System combination. If the Tester 502 was able to connect for the pre test target verification 508, but is unable to connect for the post verification 508 it is often the case that some defensive mechanism has been triggered, and a preferred embodiment therefore typically infers that network defenses have perceived an attack on the network. Information that the defense has been triggered is sent through the Gateway 118 to the Command Engine 116 in order to modify the basic tests 516. This methodology results in the ability to trip the security defenses, learn about the obstacles in place, and still accurately and successfully complete the security assessment.

Tester 502 is merely illustrative, and could be Tester 120, for example; in that case, operating system 504 would be Linux and Tester 502 would be located in New York. Of course, there is no reason why one or more additional Testers 502 could be located in New York and have the Linux operating system.

Tools and API

In detail, the API 512 for each tool 514 includes two kinds of components: an API stub 511 and a common API 510. The API stub 511 is specifically adapted to handle the input(s) and output(s) of its tool 514. The common API 510 is standard across all tools 514 and performs much of the interfacing between the Instructions and the tools 514.

As tools 514 can come from many sources—including in-house development, outsourced development, and open-source hacker and security sites—flexibility in incorporating new tools 514 into a testing system is critical for maintaining rapid time to market. The API 512 serves to enable rapid integration time for new tools regardless of the language the tool 512 is written in or the operating system 504 the tool 514 is written for.

The API 512 standardizes the method of interfacing to any tool 514 that can be added to a preferred embodiment by implementing common API 510. Using the API 512, each tool 514 can be integrated into a preferred embodiment through the addition of a few lines of code implementing API stub 511. Integration of a new tool 514, after quality assurance testing, can be completed within hours. This is a significant differentiator and time to market advantage for a preferred embodiment.

Each tool 514 should be tested before being integrated into a preferred embodiment in order to protect the integrity of a preferred embodiment system. The use of the API 512 to interface between the Gateway 118 and the tool 514 residing on the Tester 502 reduces testing cycles. The API 512 is an important buffer that allows the tools 514 to remain autonomous entities. In a standard software scenario, the entire software system should be rigorously tested after each change to the software, no matter how minute. For a preferred embodiment, however, the API 512 keeps each tool 514 as a separate piece of software that does not affect the rest of a preferred embodiment. The API 512 passes the instructions to the tool 514, and the API 512 retrieves the results from the tool 502 and passes them back to the Gateway 118. This methodology effectively reduces testing cycles by isolating each new tool 514 as a quality assurance focal point while maintaining separation between the integrity of each tool 514 and the integrity of a preferred embodiment.

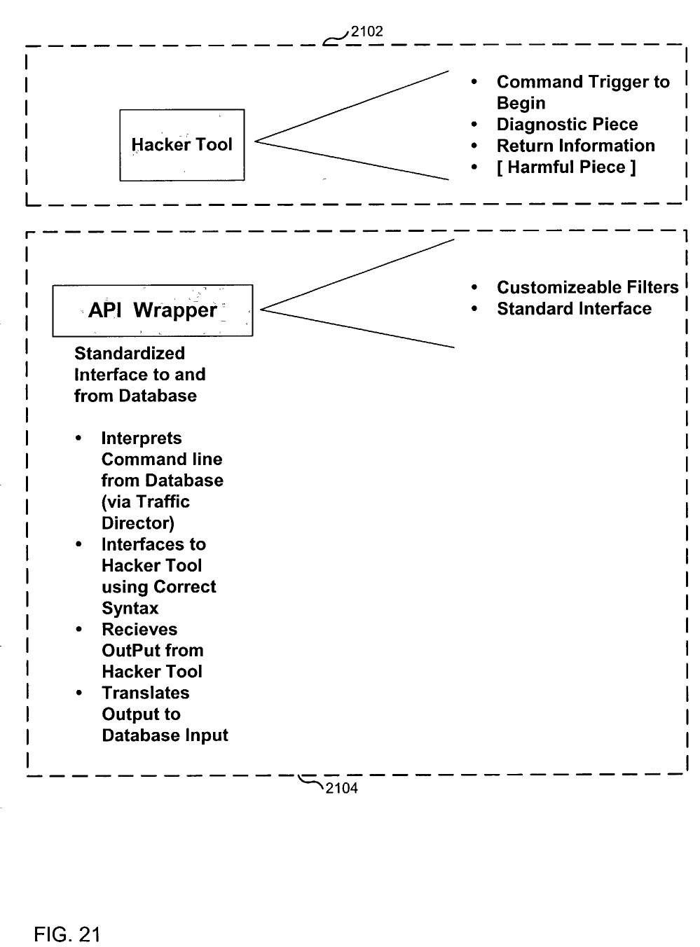

Logical overview 2100 in FIG. 21 shows a logical view of the complimentary functions of tools 514 and the API 512 wrapper. Diagram section 2102 shows a symbolic hacker tool 514 and emphasizes that a command trigger causes the hacker tool 514 to run the diagnostic piece 516 that is executed to gather information, and the information is returned, in this case, to the Gateway 118. The brackets around the harmful activity that the tool 514 performs indicate that the harmful part of the hacker tool does not damage the system 1102 in network 1002 under test. Diagram section 2104 illustrates the some of the functionality of the API 512 wrapper. Emphasizing that the information filters and command filters are customizable, providing a standard interface 510 across all hacker tools 514. That is, the interface 510 between the tools 514 and the Command Database 1702 from the Command Database 1702 perspective is a standardized interface. The API 512 interprets the command from the Command Database 1702 via the Gateway 118, interfaces to the hacker tool 514 using the correct syntax for that particular hacker tool 514, and receives output from the hacker tool 514, and translates that output to the Command Database 1702 input to be stored as raw information 214. It should be noted that in FIG. 21 the network vulnerability assessment system is using a Command Database 1702 which combines the functionality of a Command Engine 116 and a Database 114.

The API-integration of tools 514 is a big differentiator and time to market advantage for a preferred embodiment. The use of the tools 514 in their native environment and the use of the API 512 often allows a preferred embodiment to be adapted to use a new tool 514 in the same day it is found, for example in the Internet. The API 512 also isolates quality assurance testing to further shorten time to market. While a different approach can require months to adapt new tools 514, a preferred embodiment adapts to those same tools 514 in hours.

The API 512 can also normalize test results data that can become part of customer/network profile 212. The test results can be referred to as “denormalized.” In contrast, “normalized” data can be in binary format that is unreadable without proper decoding. Typically, customer network profile 212 would be stored in normalized format.

Report Generator Subsystem Functionality

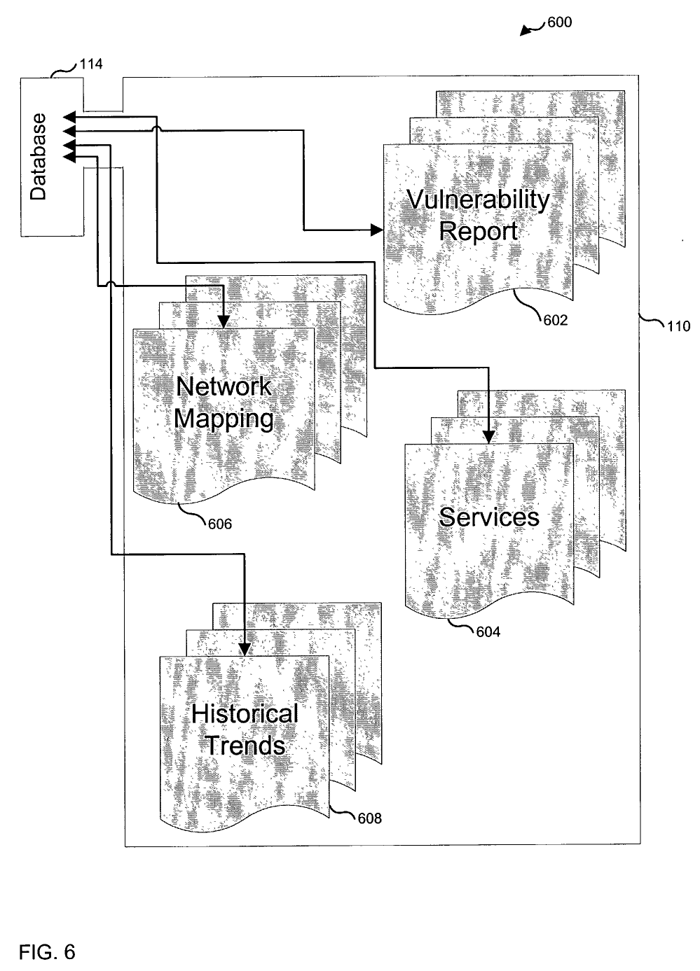

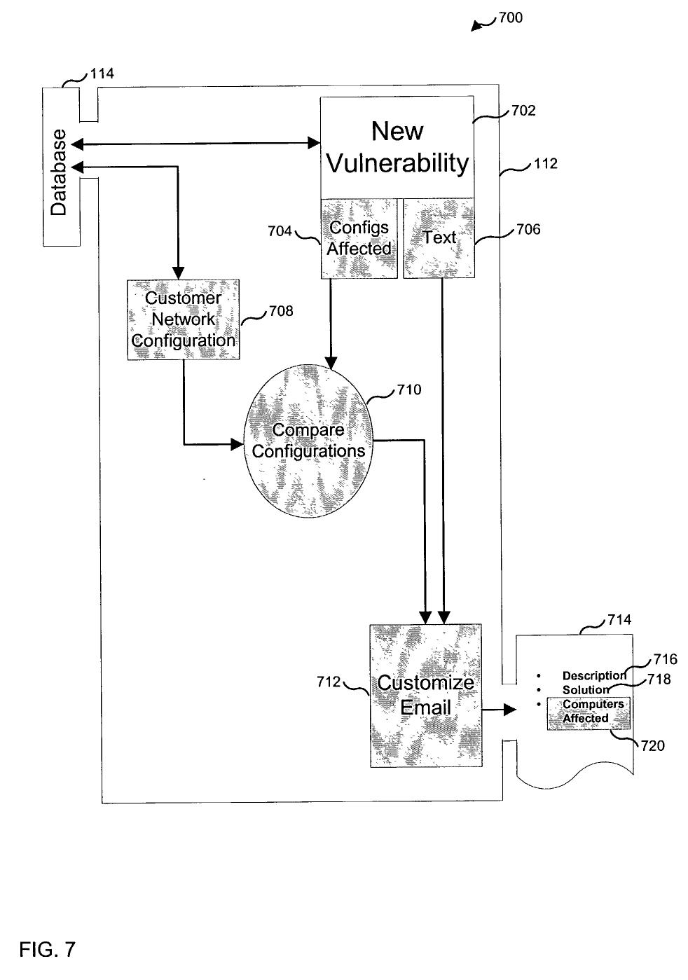

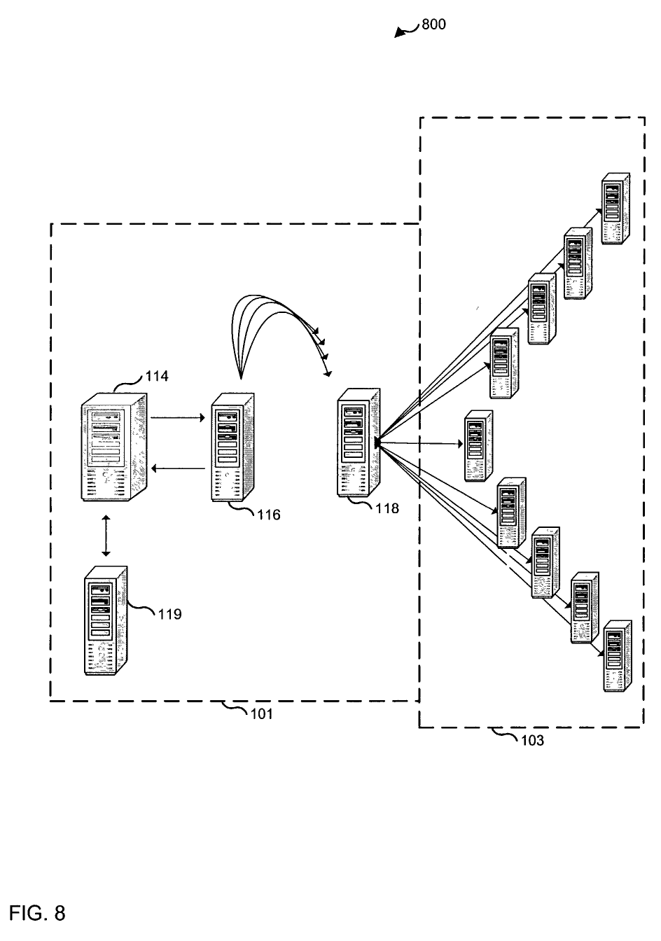

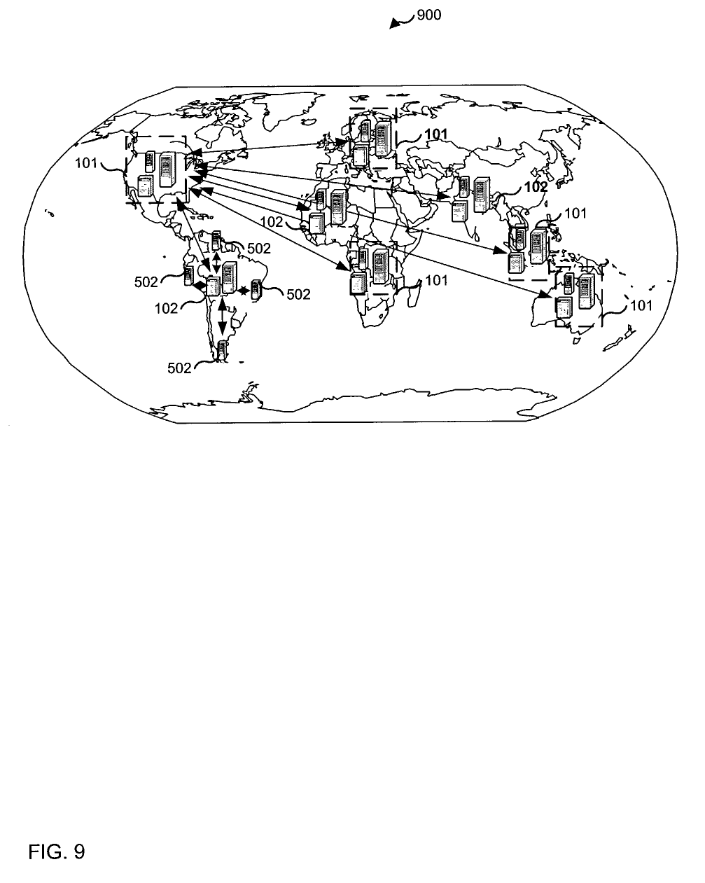

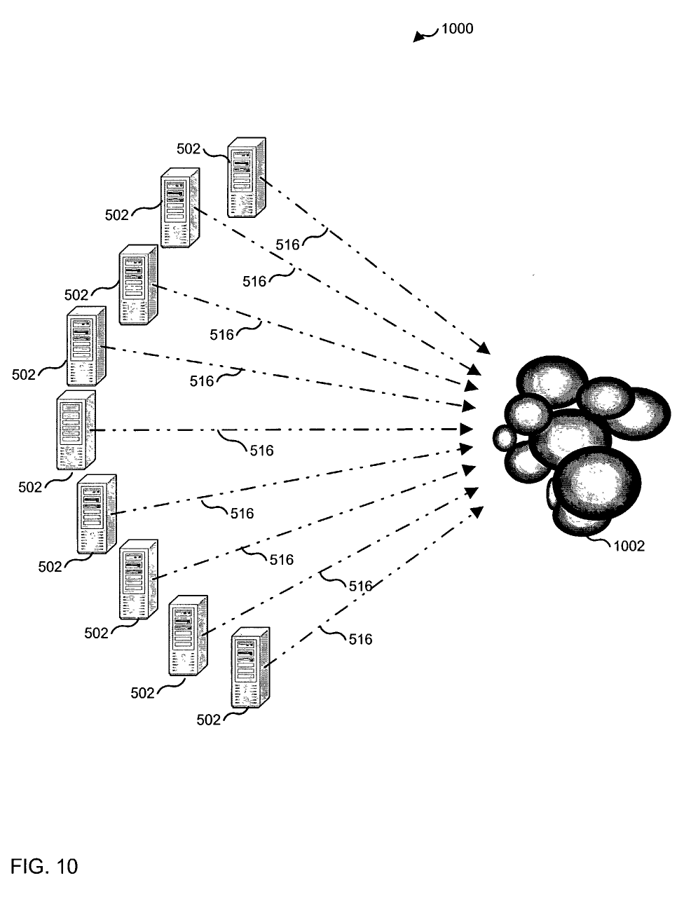

Depicted in overview 600 of FIG. 6, the Report Generator 112 uses information collected in the Database 114 about the customer's systems 1002 to generate one or more reports 2230 about the systems profile, ports utilization, security vulnerabilities, etc. The reports 2230 can reflect the profile and frequency of security services specified for provision to each customer. Security trend analyses can be provided to the extent that customer security information is generated and stored periodically. The security vulnerability assessment test can be provided on a monthly, weekly, daily, or other periodic basis and the report can be provided, for example, in hard copy, electronic mail or on a CD. New reports will continuously evolve, without substantially varying a preferred embodiment. As the customer base grows, new data mining and revenue generation opportunities that do not substantially vary from a preferred embodiment can present themselves. A report 2230 might include, for example, a quantitative score for total network 1002 risk that might be useful to an insurance company in packaging risk so that cyber attack insurance can be marketed. A report 2230 could be provided in any desired language. The level of detail in which information would be reported might include, for example, technical level detail, business level detail, and/or corporate level detail. A report 2230 might break down information by test tool 514, by positive reports 2230, by network 1002 and/or system 1102 changes. A report 2230 might even anticipate issues that might arise based on provided prospective changes. Reports 2230, raw data 214, etc. could be recorded on, for example, CD for the customer. The customer would then be able to use the data to better manage its IS systems, review actual tests, generate work tickets for corrective measures (perhaps automatically), etc. The specific exemplary reports 2230 shown in overview 600 include Vulnerability Report 602, Services 604, Network Mapping 606, and Historical Trends 608.

In a preferred embodiment, the Report Generator 112 receives customer network profile 212 from the Database 114 which is in a binary format that is generally unreadable except by the Report Generator 112. The Report Generator 112 then decodes the customer network profile. The Report Generator 112 also receives the customer profile 204 from Database 114. Based on the customer profile 204 and customer network profile 212, the Report Generator 112 polls the Database 114 for selected Report Elements 210. The Report Generator 112 then complies a report 2230 based on the selected Report Elements 210.

Full Versus Inferential Testing

Full execution of some tests will damage a system under test. In a preferred embodiment, testing stops short of causing such damage. When the testing reveals a configuration of the system under test in which a particular vulnerability is likely and subsequent testing for that particular vulnerability would harm the system under test, the subsequent testing is not performed. Rather, a warning is report of the potential for the particular vulnerability to be present, and information corresponding to the particular vulnerability is reported. While such inference is typically inconclusive, it achieves a reasonable level of thoroughness without damaging the system under test. Testing therefore would pose no risk during normal system operations; the system under test would not need to be taken offline prior to testing. Subsequent conclusive testing for the particular vulnerability could then be performed manually under a controlled scenario. Or subsequent conclusive testing for the particular vulnerability could be performed after the system under test has been taken offline.

Best Practices

Similar to inferential testing is the handling of best practices. In a preferred embodiment, review of the configuration of the system under test may reveal aspects of the configuration that do not conform to best practices. Examples of best practices include only enabling software capabilities that are actually needed or commonly enabled, avoiding naming conventions that would attract the attention of hackers, etc. An example of a naming convention that would attract the attention of hackers is naming a directory “admin”.

Targeted Reporting

In a preferred embodiment, there are five types reports: key indicator/executive summary, standard, technical summary, host detail, and action plan. The key indicator/executive summary report includes a graphical posture-at-a-glance. The standard report is the most detailed report and is very thorough. It would typically be the best report for a small system under test or for a small division, subdivision, or team level of smaller scope than the corresponding system under test. The technical summary report provides information per vulnerability and per IP address. The host detail report is broken down according to IP addresses. And the action plan report generates the information needed for a work ticket directing a technical person how to correct a particular vulnerability.

Rates of improvement, new vulnerabilities, corrected vulnerabilities, uncorrected vulnerabilities, and the age of uncorrected vulnerabilities is reported. Historical stratigraphy is applied to recognize recurring vulnerabilities and aid determination of their cause(s).

Types of reports other than the five described herein are contemplated. Mere variation in the type of report would not go beyond the scope of the present invention, and it is contemplated that innumerable report types are possible within the scope of the present invention.

These preferred embodiments of the reports are designed to enable enterprise clients to efficiently and proactively manage the continuing threat of network vulnerabilities across large, complex and dispersed network environments. Unlike other products and services that provide reports containing data presented as test results, this embodiment provides relevant, timely, information customized to an IT management framework, and applied across the enterprise to enable efficient and effective decision making. Time is of the essence for IT teams. So reports are more advantageous to the extent that they provide concise, consistent, actionable information that enables acting decisively and confidently. Customized enterprise reports allow quick identification and correction of security vulnerabilities. There are many facets to IT management—perimeter security is just one element. Reliable, on-demand information that is tailored to meet the needs of IT management is needed. New network vulnerabilities are emerging daily. Staying on top of them across a large, ever changing enterprise takes an intelligent, customized management system—not a tool that lists results to decipher, prioritize, and redistribute to team members that need it. Custom reports according to the preferred embodiment enable streamlined management and time and resource savings in fixing holes across a network, maximizing the efficiency of the valuable IT team.

A preferred embodiment will give the security posture of the system under test. Each external and internal vulnerability assessment includes a network survey, an inventory of services, an identification of vulnerabilities, and profile(s) of host(s).

For the network survey, a full active host scan is performed across the entire range of network addresses supplied by the customer in order to determine which IP addresses are active and should be fully assessed. To create an inventory of services, services that are available from the Internet will be documented so that open entry points into the network from the Internet can be mapped. An inventory of services provides a port analysis on each active device using both TCP & UDP in order to provide a listing of open ports. Open standard ports are mapped to the services generally associated with them (for example: http, smtp, etc.). Non-standard open ports are highlighted.

To identify vulnerabilities, vulnerabilities associated with devices that are visible from the Internet are identified. This can include such devices as web servers, databases, e-mail servers, employee machines, printers, routers, development computers, firewalls, and other computers or devices that are accessible from the testing devices. In host profiling, information about the host(s) being assessed is gathered. This includes operating systems indicators, application information, and product and version information. This information is useful in determining what information is available about the network from the Internet as well as tracking host changes.

Report Formats

The preferred embodiment produces the following types of reports—the customer selects the appropriate reports for his operation. The reports may be improved from time to time without departing from the scope of the invention.

Executive Summary Report

The format of an Enterprise-Wide Summary report includes number of hosts tested; number of new hosts appearing on network; total number of vulnerabilities discovered; number of vulnerabilities discovered, by risk level; number of vulnerabilities that have not been addressed since previous assessment; number of vulnerabilities fixed since the previous assessment; and historical trending of vulnerability count graphically and in table format across a defined scope, possibly including more than one division or more than one network. Thus, the source of rising vulnerabilities may be readily identified.

Logical Division Executive Summary reports contain the same information and format as the Enterprise-Wide report but for a more limited scope. This type of report is designed to provide visibility to the security level of a group of hosts that “logically” belong together, whether by reason of geographical location, corporate subsidiary affiliation, common area of responsibility, or other grouping.

Both types of executive summary reports will be presented in a combination of text and graph formats to enable rapid analysis.

Technical Summary Report

The format of the Technical Summary Report includes vulnerability and risk level information; percent reduction in vulnerabilities from previous to current assessment; fix report, listing vulnerabilities repaired with discovered vs. fixed date; new vulnerabilities appearing on host; and list of unresolved/not fixed vulnerabilities, with original discovery date.

Standard Report

The format of the Standard Report includes Graphical Summaries, Identification & Details of Discovery Vulnerabilities, Inventory of Services and Host Profile. Graphical Summaries include the number of vulnerabilities discovered by risk level, root cause, impact, and skill level required to exploit the vulnerability. Identification & Details of Discovery Vulnerabilities include risk level, root cause, skill level required to exploit the vulnerability; exposure(s) stemming from the vulnerability; and description of vulnerability. Other details of discovered vulnerabilities include security concerns relating to the vulnerability; suggested solutions to repair the security hole; and references, when available, to more in-depth information. The Inventory of Services lists and profiles in detail open ports with the service typically related to that port. Unknown or unusual ports are marked separately for easy analysis. The Host Profile aggregates non-vulnerability related information that is available from the Internet, such as reverse DNS lookup; computer name; operating system; discovery method; and application-level vendor and version.

Technical Report by Host

The format of the Technical Report by Host includes Graphical Summaries, List Summaries, Identification and Details of Discovered Vulnerabilities, Inventory of Services, and Host Profile. Graphical Summaries include the number of vulnerabilities discovered by risk level; root cause; impact; and skill level required to exploit the vulnerability. List Summaries include vulnerability discovery date “stratigraphy” which lists in chronological order (from newest to oldest) the current vulnerabilities discovered on the active host, delineated by the scan # it was discovered on. List Summaries also include new vulnerabilities and vulnerabilities fixed since previous assessment and date fixed. The date fixed will depend upon the frequency of the overall assessments. Identification & Details of Discovery Vulnerabilities includes the date the vulnerability was initially discovered on the network, first-time vulnerabilities are flagged as “New”, vulnerability recurrence information—tracks such as scan # the vulnerability first appeared on, if not new and time periods when the vulnerability was secured, if any. Inventory of services includes lists and profiles in detail open ports with the service typically related to that port. Unknown or unusual ports are marked separately for easy analysis. Host Profile aggregates non-vulnerability related information that is available from the Internet includes reverse DNS lookup, computer name, operating system, discovery method, and application—level vendor and version.

Action Plan Report

The format of the Action Plan report includes title of vulnerability, specific steps to be taken to close the hole, area for signature and data of inspection for administrator performing tasks.

Report Delivery

Reports will typically be delivered upon the completion of a monthly assessment. Reports will typically be sent as an encrypted attachment via e-mail to the appropriate contact persons designated by the customer.

Definitions Pertinent to Discussion of Types of Reports

“Loss of System(s)” refers to the destruction of operating systems or the equivalent that causes equipment to have to be reprogrammed or replaced. It also includes machines/equipment that have been compromised and need to be rebuilt to ensure you have a clean system without Trojans/Backdoors loaded on it.

“Information Theft” is the loss of sales list, customer lists, passwords, customer info, or any non-public information that a company would not want an outsider to posses.

“Downtime/Employee Idle Time” is the time spent waiting for repair or replacement of equipment after it has been damaged or compromised. This could include the entire network or merely individual machines.

“Loss of Reputation” includes the loss of reputation attributed to scenarios such as information theft made public or web site vandalizing.

“Loss of Data/Data Corruption” refers to the corruption or destruction of data to the extent that it must be recovered from tape backup systems or equivalent.

“Security Monitoring Failure” is the loss of the ability to accurately track and monitor users through log files and other such records, thus nullifying the capability to audit activities.

“Loss of Ability to Control Access” is the loss of the ability to control access. Users are able to elevate their permissions beyond their authorized status.

“Unnecessary Disclosure of Information” includes information that can be found through common tools that should only be of interest to an administrator of the company, but is available to anyone connected to the Internet.

Executive Summary

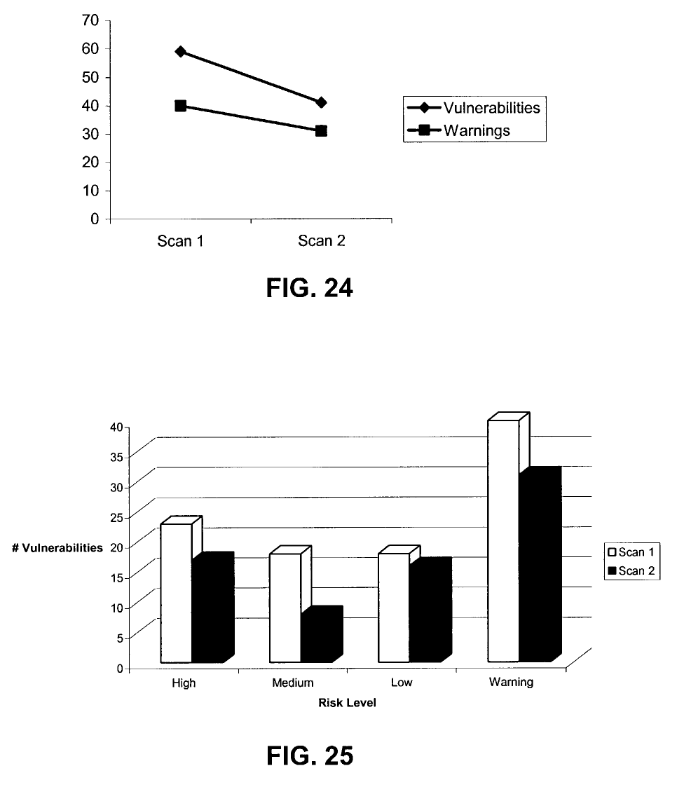

A review of FIGS. 24-29 is pertinent to understanding the Executive Summary because FIGS. 24-29 are typical of graphs included in an Executive Summary Report.

Technical Summary

Internet security can be measured as an operation metric. The flexibility of custom reports gives the ability to not only pragmatically present the actionable details needed for those responsible for remediation, but also the organizational snapshot that helps executives gauge effectiveness of spending on security and their overall security plan. This section is invaluable to management and provides a strategic understanding of the overall security posture of the network(s) with just a glance. It gives a red light, yellow light, green light indicator enabling senior executives to watch Internet security, day-to-day, just like any other commonly monitored key operational metric.

Vulnerability Trending shows total counts of vulnerabilities as well as counts grouped by risk level. Summary graphical information depicts severity, likely impact, skill level needed to exploit, and likely cause of vulnerabilities.

This report would be valuable to the CIO or other C-Level and VP level executives that need snapshot, daily updates on the “State of Security” at their company. Samples of the types of information contained in the Key Indicator section are illustrated in FIGS. 25-29.

Standard Report

This view allows the user to see at a very specific level where the trouble spots are and how long they've persisted, as well as to manage individual network administrators who are responsible for specific machines. The multiple trend views allow for ongoing management of new and unresolved issues. The report includes technical synopsis of each vulnerable host to technical managers within the IT or security team that manage groups of individuals responsible for maintaining systems on a daily basis.

Host Detail Report

This view includes both high-level analysis as well as detailed information. It is the most general, but also the most comprehensive, of all the report views in the preferred embodiment. Because the information has more of a by-vulnerability focus, the user will be able to see things like susceptibility to certain types of vulnerabilities, as well as widely known exploits and worms, across the organization. The Standard Report shows vulnerability trending showing total counts of vulnerabilities as well as counts grouped by risk level; fix reports showing count of vulnerabilities corrected vs. those left unresolved as well as a risk level of fixed and unfixed vulnerabilities; summary graphical information on severity, cause, likely impact, and sill level needed to exploit vulnerabilities; network host information identifies new nodes that are discovered during the current test as well as nodes that were present on the previous test but did not appear on the most recent one; vulnerability detail with suggested fixes, listed by risk level beginning with highest and ending with lowest; warnings: potential vulnerabilities, directions to verify and suggested fixes; vulnerabilities by host with risk level listing; and inventory of services utilized by the network. It also provides the network profile and is updated each time a new scan is performed.

This view is typically for the team member that has overall responsibility for corporate security and needs to have a very comprehensive view, both top-level and detailed of corporate security. This is most likely the Chief Security Officer or Director of IT or Network Ops.

Action Plan Report

This report contains all the breadth of information of the Standard Report combined with technical summary, but on an individual host basis. This report gives a detailed view into the “vulnerability history” of a system, and provides thorough descriptions of vulnerabilities found and how to fix them. This report includes % reduction in vulnerabilities from previous to current scan; fix report listing vulnerabilities repaired with discovered vs. fixed date; list of unresolved/not fixed vulnerabilities, with original discovery date; and host vulnerability history.

These reports are the network administrators that are responsible for maintaining the network on a daily basis.

Action Plan Reports Additional Detail

These reports contain a straightforward list of the specific tasks to be completed to secure a system. Display graphs, detailed descriptions, etc. . . . are not typically included. The report includes a basic description of the vulnerability, specific steps to be taken to close the hole, and blanks for signature and data of inspection for administrator performing tasks. This is meant to be a mechanism for managers to verify what work is being done on which machines.

Action Plans are for the technical managers that have a large team of network administrators that need specific, clear instructions on how to fix the vulnerability, no more no less. They manage teams of administrators that have multiple non-security related tasks on a daily basis, and maintain a large number of systems, and need to get in and get out quickly.

The reports typically pertain to a range of IP addresses and bear an assessment time stamp.

Executive Summary Additional Detail

The executive summary is graphically intense. The graphs are intended to be read in conjunction with table containing much of the same information. For example, vulnerability trend totals are shown in FIG. 24 together with the following table:

| | | | Total | Total |
|---|---|---|---|---|
| | | | Vulner- | |
| Assessment # | Time Period | | abilities | Warnings |
| Scan 1 | Aug. 7, 2001 | Aug. 7, 2001 | 59 | 40 |
| | 12:30 PM | 03:42 PM | | |
| Scan 2 | Aug. 14, 2001 | Aug. 14, 2001 | 41 | 31 |
| | 12:30 PM | 03:23 PM | | |

Similarly, vulnerability trend risk levels are shown in FIG. 25 together with the following table:

Vulnerability Trend -- Risk Level

| Assessment # | High | Medium | Low | Warning |
|---|---|---|---|---|
| Scan 1 | 23 | 18 | 18 | 40 |
| Scan 2 | 17 | 8 | 16 | 31 |

And a Network/Host Information section includes the following tables:

| | |
|---|---|
| Vulnerabilities repaired since previous | 18 out of 59 -- 31% reduction |
| assessment: | |
| Vulnerabilities & Warnings repaired since | 27 out of 99 -- 27% reduction |
| previous assessment: | |

Total vulnerabilities not addressed -- by age

| First Discovered | Count |
|---|---|
| Aug. 7, 2001 | 41 |

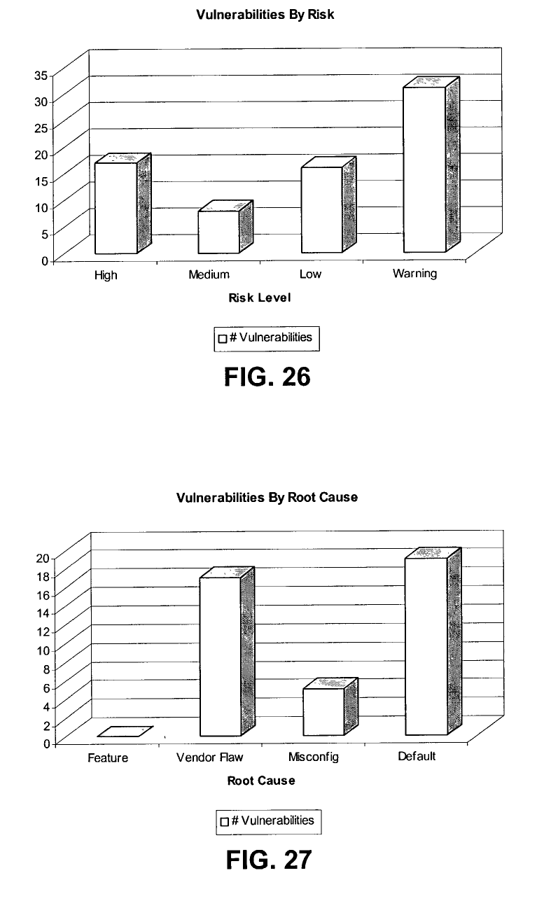

FIG. 26, together with the following tables, illustrates the risk level of vulnerabilities found in the most recent test.

Network/Host Information

| Assessment | | IP | Hosts | New |
|---|---|---|---|---|
| # | Date Completed | Addresses | Tested | Hosts Detected |
| Scan 1 | Aug. 7, 2001 | 256 | 30 | 30 |
| Scan 2 | Aug. 14, 2001 | 256 | 30 | 3 |

New Hosts detected at IP Addresses:

10.223.206.40

10.223.206.119

10.223.206.201

Hosts from previous assessment not responding during this assessment:

10.223.206.55

10.223.206.153

The root causes of current vulnerabilities are set forth in the following tables, presented together with a graph like FIG. 27.

| | |
|---|---|
| 17 | High risk vulnerabilities |
| 8 | Medium risk vulnerabilities |
| 16 | Low risk vulnerabilities |
| 31 | Warning risk vulnerabilities |

| | |
|---|---|
| 0 | vulnerabilities are caused by Software Feature |
| 17 | vulnerabilities are caused by Vendor Flaw |
| 5 | vulnerabilities are caused by Misconfiguration |
| 19 | vulnerabilities are caused by Dangerous Default Setting |

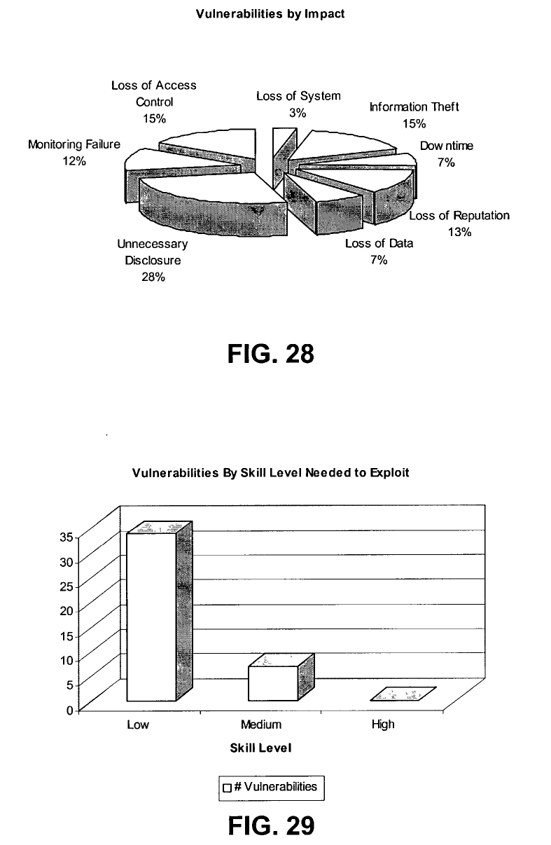

A section showing possible impacts of the current vulnerabilities includes FIG. 28 together with the following table:

| | |
|---|---|
| 5 | vulnerabilities (if exploited) could cause Loss of System |
| 23 | vulnerabilities (if exploited) could cause Information Theft |
| 10 | vulnerabilities (if exploited) could cause Downtime |
| 19 | vulnerabilities (if exploited) could cause Loss of Reputation |
| 11 | vulnerabilities (if exploited) could cause Loss of Data |
| 40 | vulnerabilities (if exploited) could cause Unnecessary Disclosure |
| 18 | vulnerabilities (if exploited) could cause Monitoring Failure |
| 23 | vulnerabilities (if exploited) could cause Loss of Access Control |

A summary of the skill levels needed to exploit the current vulnerabilities is given by FIG. 29, together with the following table:

| | |
|---|---|
| 34 | Low Skill Level |
| 7 | Medium Skill Level |
| 0 | High Skill Level |

Technical Summary Additional Detail

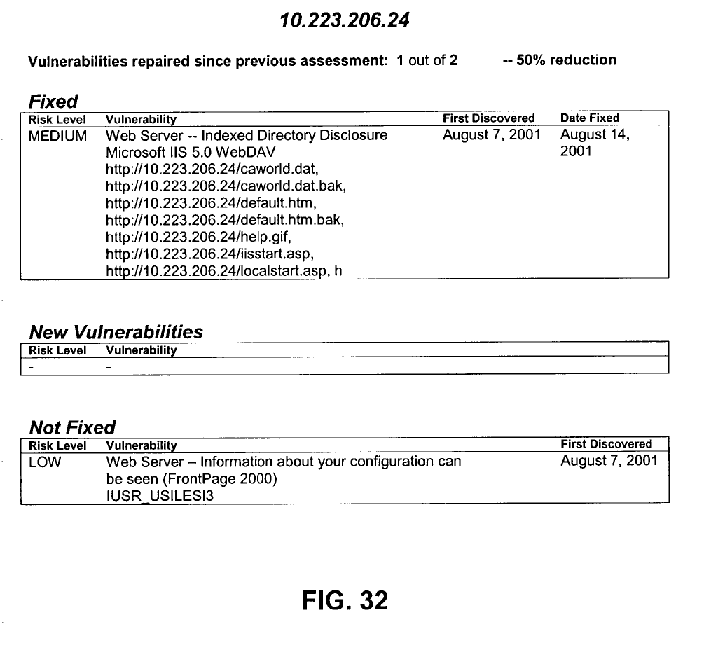

The Technical Summary report is organized according to host. FIG. 32 provides an example of the information provided regarding each host. Vulnerabilities fixed, newly discovered, and unfixed are displayed.

Standard Report Additional Detail

The Standard Report covers a great amount of detail, and is primarily organized according to vulnerability. Suborganization includes by trends, current vulnerability summary, risk breakdown, warnings, host, detailed profile, and services provided via open ports.

Much of the information of the Executive Summary is included in the Standard Report. Vulnerability trend totals and risk levels are shown as in FIGS. 24 and 25, respectively, with similar accompanying tables. A Fix Report and Network/Host Information section follow. The risk levels of current vulnerabilities and their root causes are aggregated in FIGS. 26 and 27, respectively, with similar accompanying tables. The potential impact of vulnerabilities and the skill level required to exploit them are shown in FIGS. 28 and 29, respectively, with similar accompanying tables.

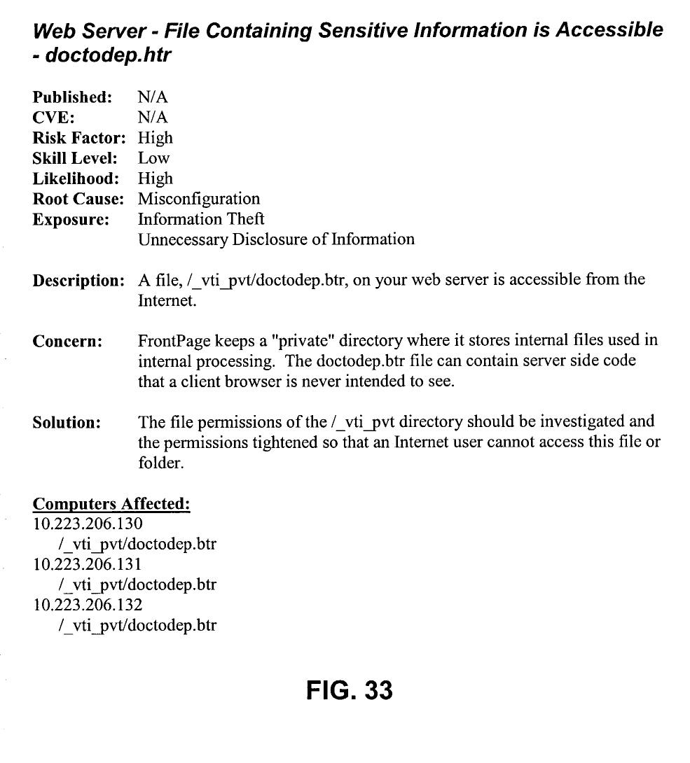

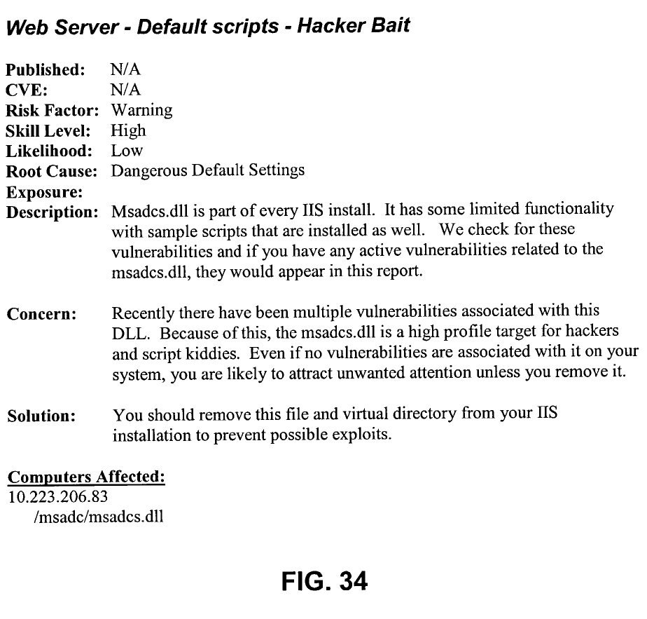

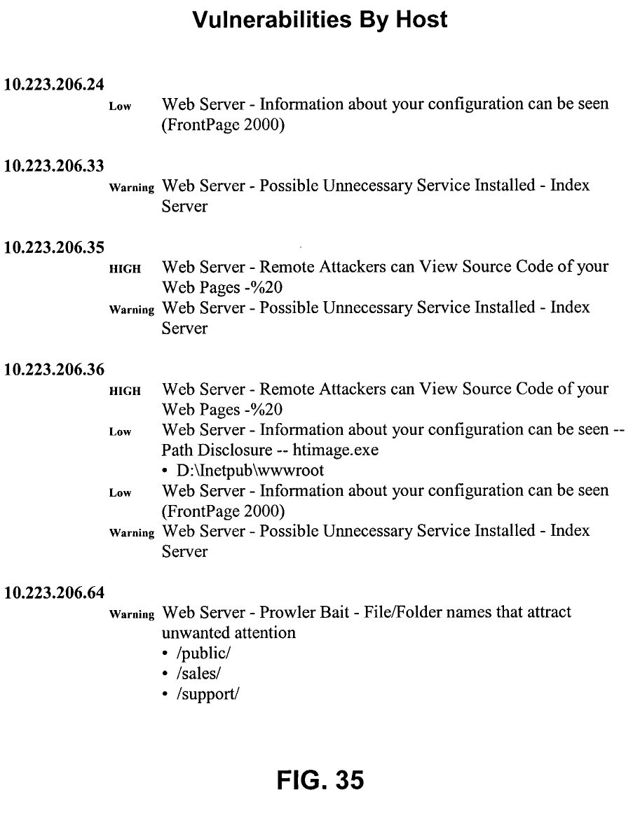

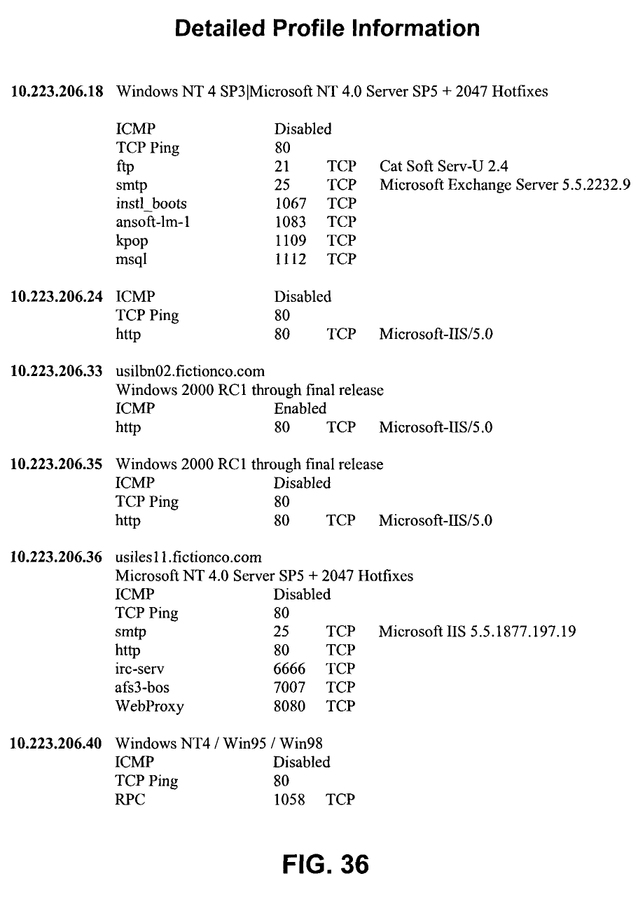

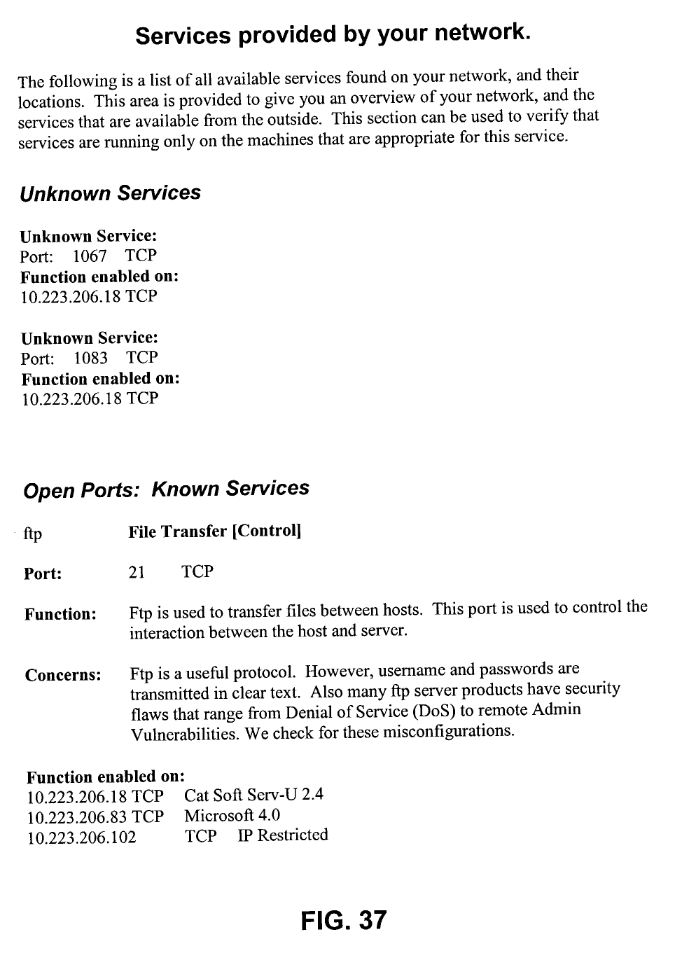

The Standard Report provides greater detail regarding vulnerabilities, however, than the Executive Summary. FIG. 33 provides an example of the information provided in the report in the Vulnerabilities by Risk part, and FIG. 34 provides an example of the information provided in the Warnings: Potential Vulnerabilities part. An example of a Vulnerabilities By Host part is shown in FIG. 35 containing risk levels and specific vulnerabilities broken down by host. An example of information contained in the Detailed Profile Information part is shown in FIG. 36. An example of information contained in the Services part is shown in FIG. 37, broken down according to open ports providing unknown and known services.

Host Detail Additional Detail

The Host Detail report will be for a single host's IP address. It will outline what vulnerabilities of the host were fixed and currently found. Vulnerabilities will be analyzed and services on the host outlined. A Fixed Report section tabulates vulnerabilities fixed, newly found, and not fixed, as illustrated in the following tables:

Fixed:

| | | First | |
|---|---|---|---|
| | | Dis- | Date |
| Risk Level | Vulnerability | covered | Fixed |
| MEDIUM | Web Server - Dangerous Cold Fusion | Aug. 7, | Aug. 14, |
| | Sample Pages- | 2001 | 2001 |
| | /cfdocs/ | | |
| | /cfdocs/expeval/ExprCalc.cfm | | |
| MEDIUM | Web Server - Dangerous Cold Fusion | Aug. 7, | Aug. 14, |
| | Sample Pages- | 2001 | 2001 |
| | /cfdocs/ | | |
| | /cfdocs/expeval/openfile.cfm | | |

New Vulnerabilities:

| Risk | |
|---|---|
| Level | Vulnerability |
| — | — |

Not Fixed:

| | | First |
|---|---|---|
| Risk Level | Vulnerability | Discovered |
| MEDIUM | Web Server - Dangerous Cold | Aug. 7, 2001 |
| | Fusion Sample Pages - | |
| | /cfdocs/ | |
| | /cfappman/index.cfm | |
| WARNING | Web Server - Prowler Bait - | Aug. 7, 2001 |
| | File/Folder names that | |
| | attract unwanted attention | |
| | /manual/ | |

The Fixed Report section also summarizes corrective action, such as by:

| | |
|---|---|
| Vulnerabilities repaired since previous | 2 out of 4 -- 50% reduction |
| assessment: | |

The Summary of Vulnerabilities Found Current part contains information analogous to FIGS. 26, 27, 28, and 29 and the tables corresponding thereto, above, adapted to correspond to a single host.

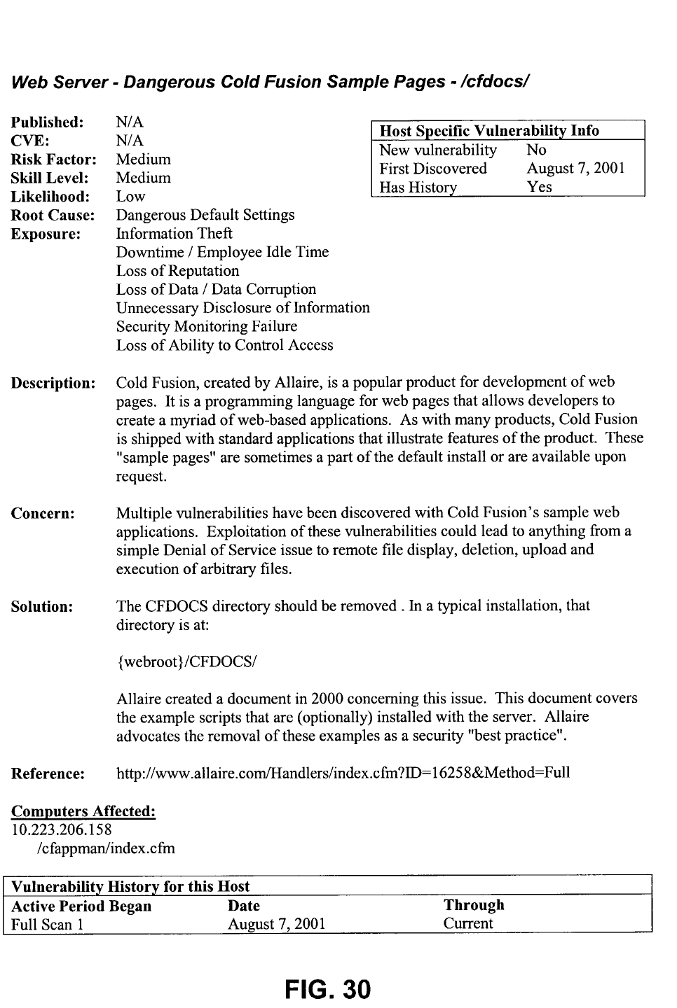

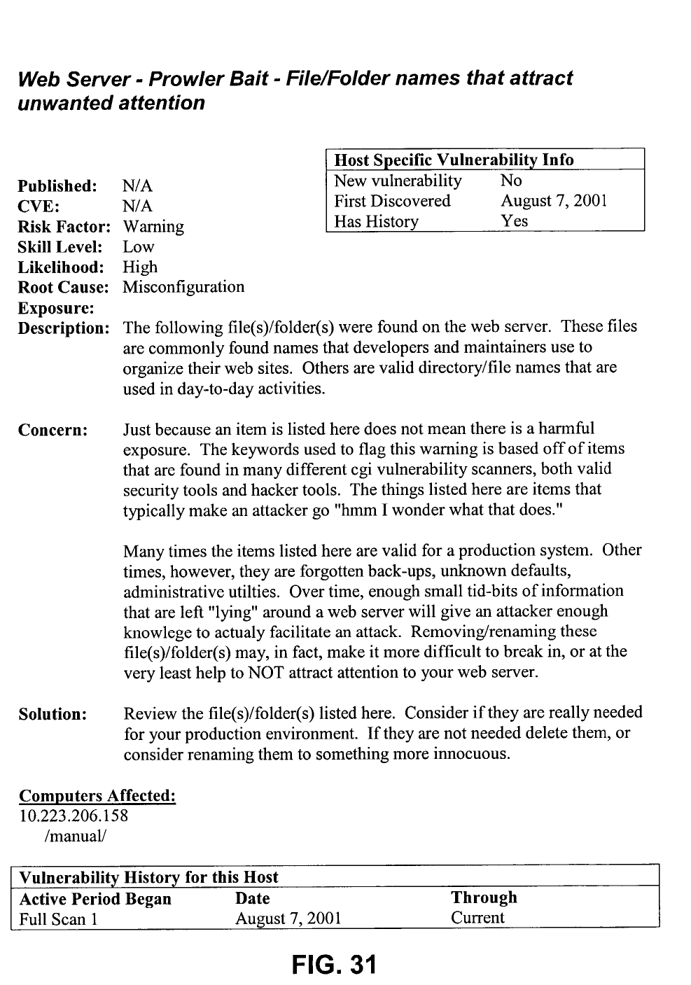

The Vulnerabilities By Risk part contains detailed information on each vulnerability disclosed in the report, as illustrated in FIG. 30, while the Warnings: Potential Vulnerabilities part contains detailed information on each warning disclosed in the report, as illustrated in FIG. 31.

The Services part shows all services available on the host and their location, i.e., port. This can lead to discovery that a service is running unnecessarily on a host, thereby creating a security risk. Information related to the service running is also displayed, for example by this table:

Open Ports: Known Services

| https | Hyper Text Transfer Protocol over SSL |
|---|---|
| | Port: 443 TCP |
| Function: | Provides external access to web servers with |
| | a layer of encryption. Most commonly used as a |
| | [secure] protocol for collecting sensitive |
| | information such as credit card numbers. |
| Concerns: | There are many vulnerabilities that have been |
| | found with all versions of web servers. HTTP over |
| | SSL will provide a remote attacker another point |
| | of entry to the web server. In addition, the secure |
| | sockets will hide the attackers URL's from any |
| | Network Intrusion Detection system you might have |
| | in place. |
| Function | TCP Netscape-Enterprise/4.1 |
| enabled on: | |
| 10.223.206.158 | |

And a detailed profile of the host is also given:

| | | | | |
|---|---|---|---|---|
| 10.223.206.158 | ICMP | Disabled | | |
| | TCP Ping | 80 | | |
| | https | 443 | TCP | Netscape-Enterprise/4.1 |

Action Plan Report Additional Detail

For clarity, the report typically addresses all issues pertaining to a particular IP address before moving on to address a subsequent IP address. Issues addressed include, for example, those set forth in the following list:

Web Server - Information about your configuration can be seen (FrontPage 2000)
Web Server - Possible Unnecessary Service Installed - Index Server
Web Server - Remote Attackers can View Source Code of your Web Pages - % 20
Web Server - Information about your configuration can be seen - Path Disclosure - htimage.exe
Web Server - Prowler Bait - File/Folder names that attract unwanted attention
Web Server - Remote Attackers can view files on your web server - showcode.asp
Web Server - Potential Dangerous Default Directories/Files
IIS 4.0 Remote Attackers can Gain SYSTEM Privileges (IDQ - Index Server Buffer Overflow
Web Server - Default scripts - Hacker Bait
Web Server - FrontPage File Permissions --/vti bin/vti aut/author.dll
Web Server - Remote Attackers can View Files on your computer - htw sample pages
Web Server - Information about your configuration can be seen - query.asp
Web Server - File Containing Sensitive Information is Accessible - doctodep.htr
Web Server - FrontPage [Hidden] Results from Submitted Form Available to the Internet
Web Server - Indexed Directory Disclosure Microsoft IIS 5.0 WebDAV
Web Server - Remote Command Execution through a web browser - UNICODE (Superfluous Decoding)
Web Server - Dangerous Cold Fusion Sample Pages - /cfdocs/
Web Server - IIS 5.0 Remote Attackers can Gain SYSTEM Privileges (printer Buffer Overflow)

Specific steps to be taken to correct the vulnerability vary based on the specific issue at hand. Examples of situationally specific steps follow:

```
  ISSUE: Web Server - Information about your configuration
  can be seen (FrontPage 2000)
  CORRECTION: There is no software solution for this
  particular problem. The only work around that has
been found to resolve this issue is to disable FrontPage Authoring
on the server. This can be done through the [FrontPage Service
Administrator].
  ISSUE: Web Server - Remote Attackers can View Source
  Code of your Web Pages - 20%
  CORRECTION: Microsoft has released security Bulletin MS00-006
  with a patch to address this issue.
  Microsoft Index Server 2.0:
  For Intel
  http://download.microsoft.com/download/winntsp/Patch/MHH/
  NT4/EN-US/Q252463t.EXE
  For Alpha
  http://download.microsoft.com/download/winntsp/Patch/MHH/
  ALPHA/EN-US/Q252463a.EXE
  Alternatively (WinNT 4.0), if indexing is not required,
  simply remove that part of the installation. With
Windows 2000, you can simply disable the service. For either NT
or 2000, the .htw extension can be unmapped from webhits.dll in
the Internet Service Manager.
  ISSUE: Web Server - Information about your configuration can
  be seen -- Path Disclosure -- htimage.exe
  CORRECTION: The functionality provided by these files is
  largely no longer needed as modern browsers
include the ability to process image maps themselves. If you
are not using server-side image maps on your website, htimage.exe
and imagemap.exe can be deleted.
  ISSUE: Web Server - Prowler Bait - File/Folder names that
  attract unwanted attention
  CORRECTION: Review the file(s)/folder(s) listed here. Consider
  if they are really needed for your
production environment. If they are not needed delete them, or
consider renaming them to something more innocuous.
  ISSUE: Web Server - Remote Attackers can view files on your
  web server -- showcode.asp
  CORRECTION: The sample files should always be removed from
  your production web servers. Many of these files are accessed
  with a virtual directory, so these sample files may not appear
  in your web manager. To remove the virtual directory that
  contains the showcode.asp page, open Inetmgr.exe and delete
  the “msadc” virtual directory.
Next delete the file showcode.asp from your server's hard drive.
  ISSUE: Web Server - Sample scripts that are vulnerable - aexp4b.htr
  CORRECTION: Always remove sample files from production web
  servers. Delete the virtual directory
[iisadmpwd] from your server via the Inetmgr.exe and delete
the files from your server's hard drive. They can typically be
found in %SystemRoot%\system32\inetsrv\iisadmpwd directory.
  ISSUE: Web Server - Potential Dangerous Default Directories/Files
  CORRECTION: Sample pages and default directories should be
  removed unless absolutely necessary for functionality of the web
  site. While there are not any problems or exploits currently
  associated with the following files, for proactive security, it
  would be considered [good security practice] to remove them.
  ISSUE: IIS 4.0 Remote Attackers can Gain SYSTEM Privileges
  (IDQ - Index Server Buffer Overflow)
  CORRECTION: Microsoft has released a patch to correct this issue.
  However, Critical Watch suggests that, unless you absolutely need
  this [feature], you install the patch and then remove the
  script mapping for .printer extensions all together.
  Patch Availability: http://www.microsoft.com/technet/security/
  bulletin/MS01-033.asp
  To Remove this feature of Index Server
  This can be performed by opening up the [Internet Services
  Manager]. It can be found in the [Control Panel]
under [Administrative Tools]. Once the Internet Services Manager is
open, highlight your server, right-click and choose [Properties]. Go
to the [Home Tab] and choose the button marked ]Configuration].
From there under the [Script Mappings] section, down near the
bottom of the list is a script mapping for
  .idq −> c:\winnt\system32\idq.dll
  .ida −> c:\winnt\system32\idq.dll
  Highlight these mapping and choose [Delete]
  ISSUE: Web Server - Default scripts - Hacker Bait
  CORRECTION: You should remove this file and virtual directory
  from your IIS installation to prevent
possible exploits.
  ISSUE: Web Server - Remote Attackers can View Files on your
  computer - htw sample pages
  CORRECTION: Sample scripts and examples should never be left
  on a production web server. The Sample scripts should be removed
  as a virtual web folder in the Internet Manager (MMC). However,
  the underlying problem is with a driver called webhits.dll.
  Microsoft has released a patch to address this issue.
  Index Server 2.0:
  Intel: http://www.microsoft.com/downloads/release.asp?
  ReleaseID=17727
  Alpha: http://www.microsoft.com/downloads/release.asp?
  ReleaseID=17728
  Indexing Services for Windows 2000:
  Intel: http://www.microsoft.com/downloads/release.asp?
  ReleaseID=17726
  Alternatively (WinNT 4.0), if indexing is not required, simply
  remove that part of the installation. With
Windows 2000, you could simply disable the service.
  ISSUE: Web Server - FrontPage File Permissions --/
  _vti_bin/_vti_aut/author.dll
  CORRECTION: Ensure that the web services on this machine are
  necessary.  Manually set the file
permissions on this author.dll to no access by the IUSR_NAME
account. Add user names and password restrictions to control who
can access and [author]/[Administer] this web server through
FrontPage. Add IP address restrictions to limit locations where web
authoring can be performed from If FrontPage is not needed: remove
the server extensions, or disable authoring through the FrontPage
server administrator tool
  ISSUE: Web Server - Information about your configuration can be
  seen -- query.asp
  CORRECTION: The sample files should always be removed from your
  production web servers. Many of
these files are accessed with a virtual directory, so these sample files may
not appear in your web manager To remove the virtual directory
that contains the query.asp page, open Inetmgr.exe and delete the
[iissamples] virtual directory. Next delete the file query.asp
from your server's hard drive.
  ISSUE: Web Server - File Containing Sensitive Information is
  Accessible - doctodep.htr
  CORRECTION: The file permissions of the /_vti_pvt
  directory should be investigated and the permissions
tightened so that an Internet user cannot access this file or folder.
  ISSUE: Web Server - FrontPage [Hidden] Results from Submitted
  Form Available to the Internet
  CORRECTION: Verify the permissions on the parent directory [/
  _private] deny the [anonymous] user
access to the folder and re-apply the permissions to the files in the folder.
  Alternatively, you can run the [FrontPage Server Administrator] and
  choose [Check and Fix]. If you choose
this path, when the process is through be sure to open the server with a
FrontPage client as the web admin and double check the permissions
through the FrontPage Explorer. The Check and Fix option can
sometime inadvertently open the permissions to allow everybody
access to author pages.
  ISSUE: Web Server -- Indexed Directory Disclosure Microsoft
  IIS 5.0 WebDAV
  CORRECTION: If you are not using Index Server (for example,
  you don't have content on your Web site
that you want to have searched), disable or uninstall the service.
  OR
  In directories that contain sensitive information, make
  sure to disable the [Index this resource]option on the
[Virtual Directory] tab. Open inetmgr.exe and Expand Default
Web Site Right Click on the Virtual Directory and select Properties
Uncheck the box labeled Index this Resource.
  ISSUE: Web Server - Remote Command Execution through a web
  browser - UNICODE - (Superfluous
Decoding)
  CORRECTION: The web root for the web server should never
  be located on the same drive as the system
information. (It is installed on the same drive, c:\, as the
system information by default.) The web root should be moved to
a different drive and the following patch should be installed.
  Microsoft has released a patch to correct this issue and
  you should install the patch. This patch is a
cumulative patch that includes the functionality of all security
patches released to date for IIS 5.0, and all patches released
for IIS 4.0 since Windows NT(r) 4.0 Service Pack 5. A complete
listing of the patches superseded by this patch is provided in
the web-hosted security bulletin, in the section titled
[Additional information about this patch].
  ISSUE: Web Server - Dangerous Cold Fusion
  Sample Pages - /cfdocs/
  The CFDOCS directory should be removed. In a typical
  installation, that directory is at
  {webroot}/CFDOCS/
  CORRECTION: Allaire created a document in 2000
  concerning this issue. This document covers the
example scripts that are (optionally) installed with the
server. Both Allaire and Critical Watch, advocate the
removal of these examples as a security [best practice].
  ISSUE: Web Server - IIS 5.0 Remote Attackers can
  Gain SYSTEM Privileges (.printer Buffer Overflow)
  CORRECTION: Microsoft has released a patch to correct
  this issue. However, Critical Watch suggest that,
unless you absolutely need this [feature], that you install
the patch and then remove the script mapping for printer ex-
tensions all together.
  Patch Availability: http://www.microsoft.com/
  technet/security/bulletin/ms01-023.asp
  To Remove the IPP Feature
  This can be performed by opening up the [Internet
  Services Manager]. It can be found in the [Control Panel]
under [Administrative Tools]. Once the Internet Services
Manager is open, highlight your server, right-click and choose
[Properties]. Go to the [Home Tab]and choose the button
marked [Configuration]. From there under the [Script
Mappings]section, down near the bottom of the list is a script
mapping for .printer −>
c:\winnt\system32\msw3prt.dll extension. Highlight
this mapping and choose [Delete].
  Verifying patch installation:
  To verify that the patch has been installed on the
  machine, confirm that the following registry key has been
created on the machine: HKEY_LOCAL_MACHINE\
SOFTWARE\Microsoft\Updates\Windows 2000\SP1\Q296576.
  To verify the individual files, use the date/time and version
  information provided in the following registry
key: HKEY_LOCAL_MACHINE\SOFTWARE\
Microsoft\Updates\Windows 2000\SP1\Q296576\Filelist.
```

Further Discussion of Report Generator

A preferred embodiment includes a systematic sequence for reporting on information gained through testing. A tester executes a test on a system under test, and the test program returns raw test information to the tester. The tester forwards the raw test information to a database. The report generator may then retrieve vulnerability information corresponding to the raw test information from the database. The report generator polls a library for report modules corresponding to the vulnerabilities and assembles the report modules into a report.

A preferred embodiment tracks and reports on uncorrected issue trends and recurring issue trends. It compares assessments in order to track and report on corrected vulnerabilities, new vulnerabilities, and aging of uncorrected vulnerabilities.

A preferred embodiment stores raw test information for later use. Examples of later use include creation of reports in new formats, comparison with later raw test information, etc.

Example of Flexible Reporting by a Preferred Embodiment

A fictitious company named Global Widgets, Inc. (GWI) wishes to receive vulnerability reports based on testing of its network. GWI has three divisions: Global Widgets Europe (GWE), Global Widgets United States (GWA), and Global Widgets Asia (GWA). Each of the divisions has two sections: Global Widgets Boxes (GWB) and Global Widgets Controls (GWC). The GWI network spans all of these divisions and sections.

First the entire GWI network is tested and the report generator is ultimately provided with corresponding report modules.

A high-level report is provided to GWI senior management with aggregate information and breakouts by division and by section. A high-level report is provided to GWE senior management with aggregate information for GWE's part of the network only and breakouts by section. A high-level report is provided to GWU senior management with aggregate information for GWU's part of the network only and breakouts by section. A high-level report is provided to GWA senior management with aggregate information for GWA's part of the network only and breakouts by section.

Technical reports are provided to GWE information services personnel on GWE's part of the network. Technical reports are provided to GWU information services personnel on GWU's part of the network. Technical reports are provided to GWA information services personnel on GWA's part of the network.

Likewise, section managers in each division receive high-level reports on the part of the network serving their division and section.

Each recipient, whether team, person, etc., receives the type of report appropriate to that recipient. Recipients can be differentiated by position, responsibility, authorization, etc.

Early Warning Generators Subsystem Functionality

The Early Warning Generator subsystem 112 can be used to alert 714 relevant customers to early warnings on a periodic or aperiodic basis that a new security vulnerability 702can affect their system. The alert 714 tells the customer which vulnerability 702 can affect them, which computers 1102 in their network 1002 are affected, and what to do to reduce or eliminate the exposure.

On a daily basis, for example, when new security vulnerabilities 702 are found by researchers or provided through other channels, a preferred embodiment compares 710 each configuration 704 affected by new vulnerability 702 against each customer's most recent network configuration test result 708. If the new vulnerability 702 can be found to affect the customer systems 1102 or networks 1002 then an alert 714 would be sent to the customer, for example, via e-mail 712. The alert 714 can indicate the detail 716 of the new vulnerability 706, which machines are affected 720, and/or what to do 718 to correct the problem. Only customers affected by the new security vulnerabilities 702 receive the alerts 714. This reduces the “noise” of the great number of vulnerabilities 702 that are frequently published, to just those that affect the customer.

Note that the steps of customizing e-mail 712 and notification 714 need not relate to e-mail technology, but can be any method of communicating information.

A customer would also have the option of tagging specific vulnerability alerts 714 to be ignored and therefore not repeated thereafter, for example, where the customer has non-security reasons to not implement corrective measures. Corrective measures that were to be implemented by the customer could be tracked, the responsible technician periodically reminded of the task, a report made upon completion of implementation of corrective measures, the effectiveness of corrective measures could be checked immediately by running a specific test 516 for the specific vulnerability 702 corrected.

Early Warning Alerts

The Early Warning Alerts service gives customers an early warning about new network-based security threats as they emerge. These alerts are customized to the customer's environment, so only relevant vulnerabilities are sent. Vulnerabilities that do affect a customer's network are detailed and the specific devices that are affected are pinpointed to enable IT staff to secure the network.

Early Warning Process

The Early Warning Alert Process includes the customer's profile is automatically updated with assessment, new vulnerabilities are compared to the customer's profile, affected the customers are notified, alerts are sent to the customer designated contact, and types of vulnerabilities the sent are specific to security holes that can be exploited remotely.

Early Warning Alert Delivery

The Early Warning Alert will be delivered daily if applicable and will be sent via e-mail to the appropriate contact persons designated by the customer.

On-Demand Assessment

The on-demand option allows network administrators to request an additional vulnerability assessment without waiting until the next scheduled assessment. This option is useful for networks that are anticipating change or for networks that require security verification after a severe Rapid Alert of discovered vulnerability. Vendor will provide the customer with the capability to request assessments to test the Customer Systems at anytime.

Security Rating

In a preferred embodiment, rapid correction of vulnerabilities discovered via early warnings, scheduled reports, etc. would contribute to a better security rating. The security rating could then be a factor in the setting of insurance premiums for cyber attack insurance. Alternatively, the security rating could affect the valuation of the company for investment purposes, credit worthiness, etc. Innumerable other applications of the security rating are contemplated and would be readily apparent to one of ordinary skill in the art.

A preferred embodiment is a method of generating a report. Generic vulnerability data is received. Test results make up stored raw data. Based on comparison of the generic vulnerability data with the stored raw data, a plurality of raw vulnerabilities is determined. Based on a report recipient, a plurality of selected vulnerabilities is selected. Each of the plurality of selected vulnerabilities is contained in the set of the plurality of raw vulnerabilities.

For each of the plurality of selected vulnerabilities, a selected report element is selected. Each selected report element is selected, based on the report recipient, from a plurality of report elements that corresponds to the selected vulnerability. The selected report elements are included in a report. And the report is transmitted to the report recipient.

In another preferred embodiment, the system under test is tested. New raw data is received which include test results. The new raw data is stored. A plurality of new raw vulnerabilities based on the new raw data is determined. Then the new raw vulnerabilities are compared to the raw vulnerabilities of the plurality of raw vulnerabilities to ascertain corrected vulnerabilities including the raw vulnerabilities of the plurality of raw vulnerabilities that are not among the new raw vulnerabilities.

Selected report elements are selected based on the corrected vulnerabilities, and the selected report elements are included in a report. Then the report is transmitted to the report recipient.

In another preferred embodiment, the new raw vulnerabilities are compared to the raw vulnerabilities of the plurality of raw vulnerabilities to ascertain uncorrected vulnerabilities including the raw vulnerabilities of the plurality of raw vulnerabilities that are among the new raw vulnerabilities. Then selected report elements are selected based on the uncorrected vulnerabilities.

In another preferred embodiment, metrics describing characteristics of the corrected vulnerabilities are formulated. Characteristics each of the corrected vulnerabilities include duration and percentage. Duration is the duration of time from the time that a report was transmitted with at least one report element corresponding to the now corrected vulnerability until the now corrected vulnerability was first determined to be corrected. Percentage is the percentage of the raw vulnerabilities of the plurality of raw vulnerabilities that became corrected vulnerabilities. Metrics describing characteristics of the uncorrected vulnerabilities are formulated. Characteristics each of the uncorrected vulnerabilities include duration and percentage. Duration is the duration of time from the time that a report was transmitted with at least one report element corresponding to the uncorrected vulnerability until the uncorrected vulnerability was last determined to be uncorrected. Percentage is the percentage of the raw vulnerabilities of the plurality of raw vulnerabilities that are uncorrected vulnerabilities.

Integration with Enterprise Management Systems

Reports, including early warnings and scheduled reports, can be transmitted to a recipient by a variety of means. In a preferred embodiment, a report is transmitted to the recipient by direct feed into the recipient's NT-based enterprise management system (EMS) via SNMP traps. The EMS would then assign the information per its regular handling protocol. For example, the EMS could easily automate work ticket generation based on the information in an action plan report.

Adding New Tools to a Preferred Embodiment

New security vulnerability assessment tools 516 can regularly be added to a preferred embodiment. The methodology of how to do this can be beneficial in managing a customer's security risk on timely basis.

The tools 514 themselves, with their API 512, can be added to the Tester's RMCT (again, Repository Master Copy Tester) 119. An RMCT 119 can be a Tester 502 located in the Test Center 102. These RMCTs 119 can be used by the Testers 502 that can be web-hosted around the world to obtain the proper copy. The name of the tool 514, its release number, environmental triggers, etc. can be added to the Command Engine's Tool Management module 314. Each vulnerability 702 that the new tool 514 checks for can be added to the Vulnerability Library 206. An addition may need to be made to the Database 114 schema so that the raw output 214 of the test is warehoused.

When a new test 516 is conducted, the Command Engine 116 uses the identifiers of the new tools 514 with their corresponding parameters inside the Tool Initiation Sequencer 312. The tool information is sent through the Gateway 118 to the Testers 502. The Tester 502 first checks 506 for the existence of the tool 514 instructed to run. If the tool 514 does not exist, it retrieves the install package with the API 512 from the RMCT 119. If the tool 514 does exist, it can verify that the version of the tool 514 matches with the version in the instruction set it received. If the instruction set version does not match the tool version, the Tester 502 retrieves the update package from the RMCT 119. In this manner the ability to update multiple Testers 502 around the world is an automated process with minimum work.

The RMCT 119 is part of the Test Center 101. The RMCT 119 can be protected since it is a device that is enabled to share the tools 514 with other machines. The RMCT 119 can communicate with Testers 502 through the Gateway 118, but that need not be the case in all embodiments. The RMCT 119 does not operate as a normal Tester 502. The RMCT's 119 purpose is to provide the updates (including version rollbacks) to the Tester 502. A possible version control software and communication might be Concurrent Versioning System (CVS) over Secure Shell (SSH). The performed embodiment might actually utilize any type of version control with any type of encryption or other similarly functioned technology. A preferred embodiment has the flexibility to utilize either pushing or pulling technology. Currently, a preferred embodiment includes a single RMCT 119: CVS is OS neutral as it stores the source code and binary executables for multiple OS's. However, the number of Testers 502 that need to be updated can exceed the ability of a single RMCT 119. To meet this potential need, the design of the system allows for multiple RMCTs 119.

VM Ware is a commercial program that enables multiple operating systems to run on the same computer. For example, VM Ware enables NT to run on a Linux box. The user has the ability to toggle back and forth without rebooting. The possibility of using VM Ware, or a similar product, exists to enable different operating systems to be used without the need for separate machines for each type of operating system.

Updating Additional Preferred Embodiment Systems

Preferred embodiment systems sold to customers can be equipped with the capability to receive automatic updates as part of their support services. These updates can include new tools 514 to test for new vulnerabilities 702 and newly researched or discovered vulnerabilities 702. These preferred embodiment systems can replicate the Early Warning Generator 112 system for their customers through these active updates. In this way all preferred embodiment systems are up-to-date on a frequent basis.

An effective way to manage security risk is to minimize the window of exposure for any new security vulnerability that affects customer systems. A preferred embodiment is a self-updating risk management system that can be virtually always up-to-date.

Overview diagram of an alternative embodiment 1700 depicts a network vulnerability assessment system in which the functionalities of the Command Engine 116 and the Database 114 are combined into one unit shown as Command Database 1702 which issues attack instructions 138 to Gateway 118 resulting in attack command 140 being transmitted to one of the three shown Tester server farms 1704.

A Preferred Embodiment Attack/Test Methodology

The Command Engine 116 operates as a data-driven process. This means that it can respond to and react to data or information passed to it. Information is passed through the Command Engine 116 as it is gathered from the systems being tested 1002. Responding to this information, the Command Engine 116 generates new tests 516 that can, in turn, provide additional information. This iterative process continues until testing has been exhausted. This methodology offers extreme flexibility and unlimited possibilities.

This framework was created so that as new methodologies or techniques are discovered they can be implemented easily. The following discussion gives examples of some of the different methodologies used by a preferred embodiment and that underscore the ability to react to the environment it encounters.

Having a distributed, coordinated attack that tests customer systems has several advantages over alternate vulnerability scanning methodologies.

A typical Intrusion Detection System (IDS) has various methodologies to identify cyber attacks. Various responses are possible: blocking further communications from the same IP address, for example.

There are alternatives around the problem of blocking by security devices. For example, the company performing the vulnerability assessment can coordinate with the corporation being tested. A door may need to be opened in the firewall to allow the testing to occur without interference. This situation may be less than ideal from a network administrator's standpoint as it creates a security weakness and consumes valuable time from the administrator. Another option can be to perform the vulnerability assessment on-site from inside the network. Internal vulnerability assessments will not be affected by the security devices. Internal assessments, however, do not indicate which devices are accessible from the Internet and are also limited to the capabilities of the software.

The distributed model can evade defensive security measures such as IDS. By being distributed, the assessment can be broken down into many basic tests 516 and distributed to multiple Testers 502. Since each machine only carries a minute part of the entire test, it is harder for defensive mechanisms to find a recognizable pattern. Firewalls and Intrusion Detection Systems rely on finding patterns in network traffic that reach a certain threshold of activity. These patterns are called attack signatures. By using the distributed model we are able to make the attack signature random in content, size, IP source, etc. so as to not meet typical predetermined thresholds and evade defenses. Hence this approach is figuratively referred to as “armor piercing”. Additionally, each Tester 502 can actually have multiple source addresses to work with. This means that each Tester 502 is capable of appearing to be a different computer for each source address it has.

Basic tests 516, originating from various points on the Internet, provide a fairly realistic approach to security testing. Cyber attacks often stem from an inexperienced attacker simply trying out a new tool 514. The attacker can find a single tool 514 that exploits one specific service and then begin to scan the Internet, randomly choosing networks 1002 to target. Samples of firewall logs from corporations and individuals show this to be a common attack activity.

In addition, each basic test 516 takes up a very small amount of Tester 5-2 resources. Because of this, each Tester 502 can perform thousands of basic tests 516 at any given time against multiple networks 1002 simultaneously.

A preferred embodiment is very scalable. The transaction load can be shared by the Testers 502. As more customers need to be serviced and more tests 516 need to be performed, it is a simple matter of adding more Testers 502 to the production environment. In addition to the test approaches described, Bombardment is an option. In Bombardment, many Testers 502 are used to flood a system 1102 or network 1002 with normal traffic to perform a “stress test” on the system, called a distributed denial of service.

Frontal Assault

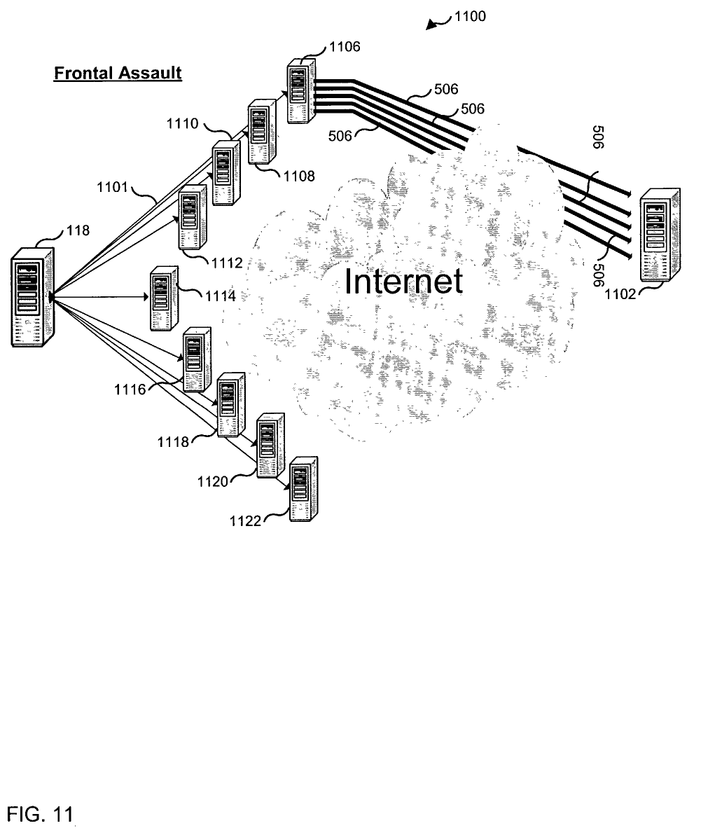

Depicted in overview 1100 of FIG. 11, the Frontal Assault is designed to analyze networks 1002 that have little or no security mechanisms in place. As the name implies, this testing methodology is a straightforward, open attack that makes no attempt to disguise or hide itself. It is the quickest of methodologies available. Typically, a network 1002 with a moderate level of security can detect and block this activity. However, even on networks 1002 that can be protected, the Frontal Assault identifies which devices 1102 are not located behind the security mechanism. Mapping and flagging devices that are not behind security defenses gives a more accurate view of the network 1002 layout and topology. Test instruction 1101 is sent from Gateway 118 to Tester 1106 to launch all tests 516 at system 1102. Other Testers (1108 through 1122) are idle during the testing, with respect to system 1102.

Guerrilla Warfare

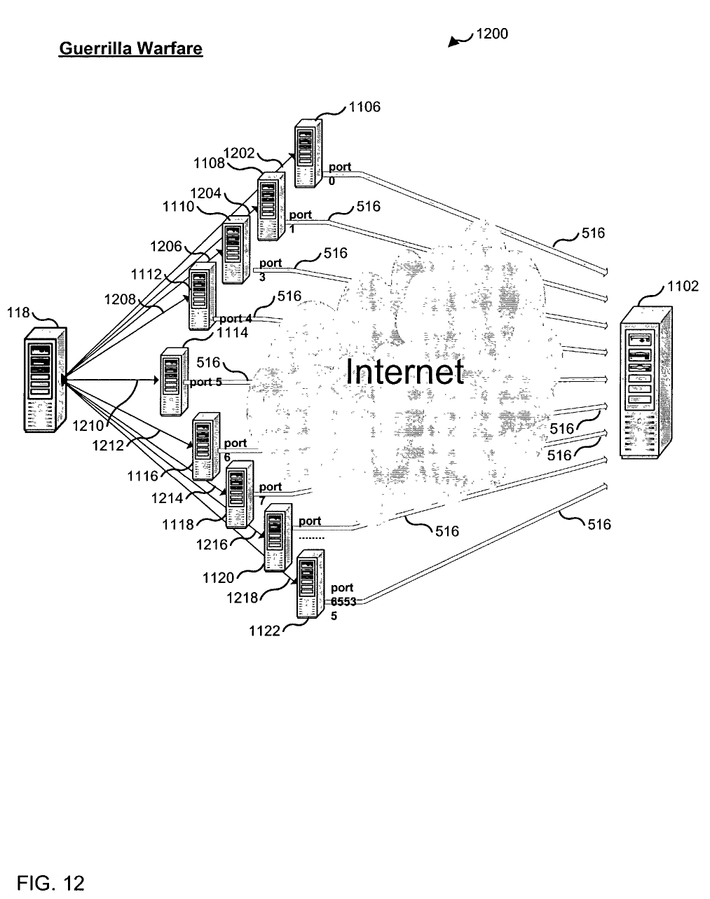

Depicted in overview 1200 of FIG. 12 is “Guerrilla Warfare.” If Frontal Assault has been completed and a heightened level of security detected, a new methodology is needed for further probing of systems 1102 in the target network 1002. The Guerrilla Warfare method deploys randomness and other anti-IDS techniques to keep the target network defenses from identifying the activity. Many systems can detect a full Frontal Assault by pattern recognition.

However, when the methodology is changed to closely mimic the activities of independent random cyber attackers, many defensive systems do not notice the activity. Such attackers choose a single exploit and scan random addresses for that one problem. There are 131,070 ports for TCP & UDP per every computer 1102 on the network 1002 being analyzed. Port tests are be distributed across multiple Testers 502 to distribute the workload and to achieve the results in a practical period of time.

Other features of this methodology include additional anti-IDS methods. For instance, many sites deploy SSL (secure socket layers) on their web server so that when customers transmit sensitive information to the server it can be protected by a layer of encryption. The layer of encryption prevents a malicious eavesdropper from intercepting it. However, a preferred embodiment uses this same protective layer to hide the security testing of a web server from the network Intrusion Detection system.

Test instructions 1202 through 1218 are sent by Gateway 118 to Testers 1106 through 1122, respectively, generating appropriate tests 516 in accordance with the Guerrilla Warfare methodology.

Winds of Time

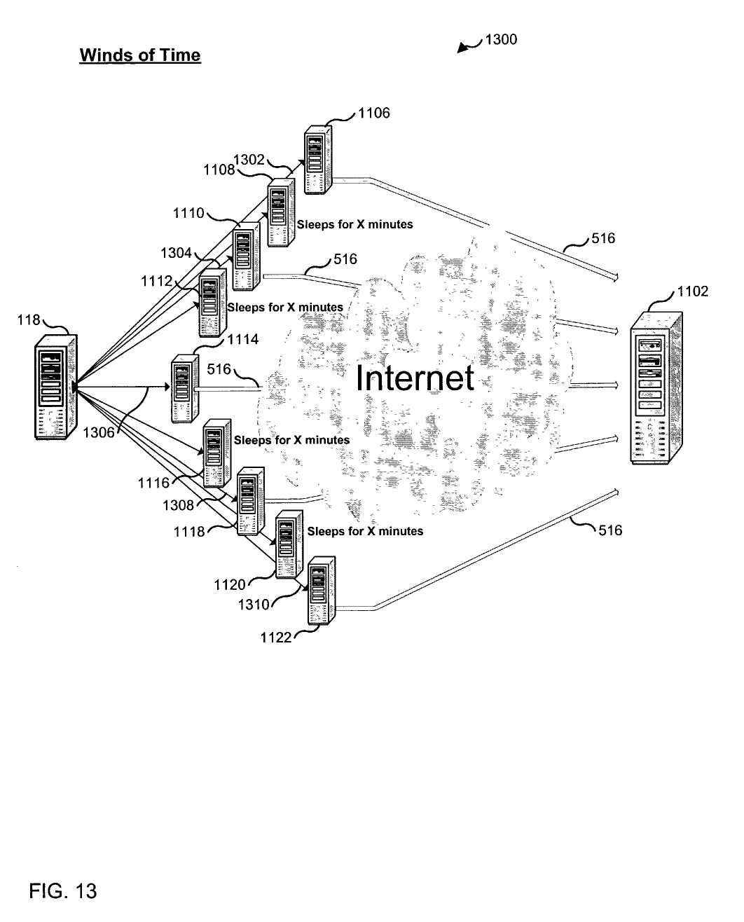

Depicted in overview 1300 in FIG. 13, the “Winds of Time” slows down the pace of an set of tests until it becomes much more difficult for a defensive mechanism sensitive to time periods to detect and protect against it. For example, a network defense can perceive a single source connecting to five ports within two minutes as an attack. Each Tester 502 conducts a basic test 516 and then waits for a period of time before performing another basic test 516 for that customer network 1002. Basic tests 516 for other customers who are not receiving the Winds of Time method can continue without interruption. Anti-IDS methods similar to those used in the Guerrilla Warfare methodology can be deployed, but their effectiveness is typically magnified when the element of time-delay is added. The Guerrilla and Wind of Time test methodologies can create unlimited test combinations.

Note that when a Tester (one of Testers 1106 through 1122) is said to “sleep for X minutes” in FIG. 13, the particular values for X do not need to be identical. For example, Tester 1108 will not test system 1102 for ten milliseconds, while Tester 1120 will not test system 1102 for five seconds. However, it should be noted that the sleeping Testers 1108, 1112, 1116, and 1120 can be testing other systems during this “sleep” time. Meanwhile, instructions 1302 through 1310 are sent from the Gateway 118 to the Testers 1106, 1110, 1114, 1118, and 1122 which are testing 516 system 1102.

Data Driven Logic

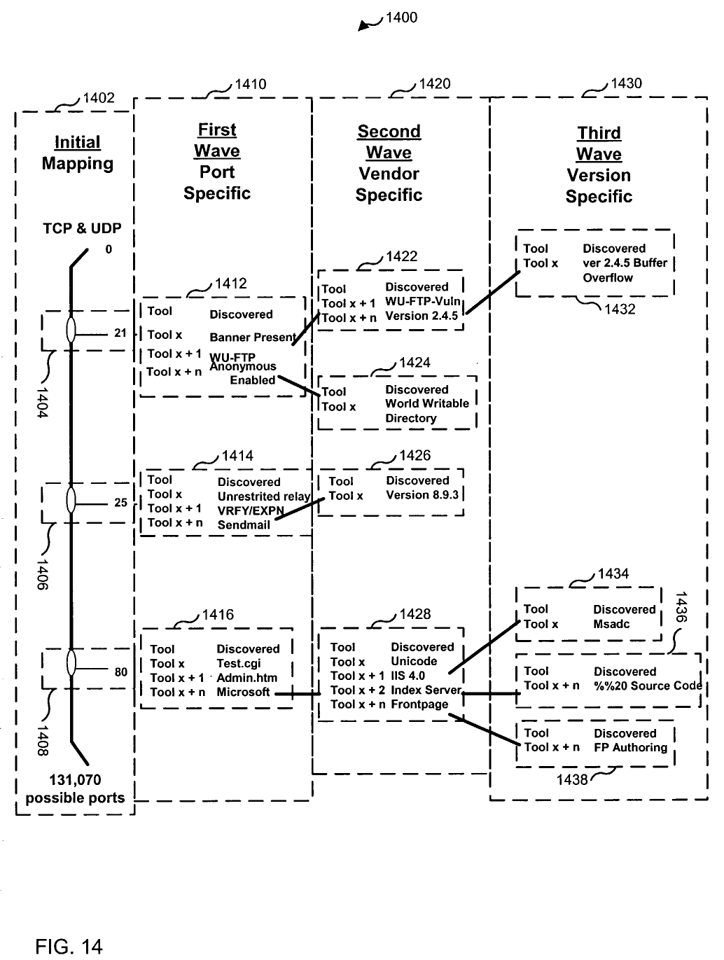

Overview 1400 in FIG. 14 illustrates a sample of the attack logic used by a preferred embodiment. Prior to the first “wave” 1410 of basic tests 516, an initial mapping 1402 records a complete inventory of services running on the target network 1002. An initial mapping 1402 discloses what systems 1102 are present, what ports are open (1404, 1406, and 1408) what services each system is running, general networking problems, web or e-mail servers, whether the system's IP address is a phone number, etc. Basic network diagnostics might include whether a system can be pinged, whether a network connection fault exists, whether rerouting is successful, etc. For example, regarding ping, some networks have ping shut off at the router level, some at the firewall level, and some at the server level. If ping doesn't work, then attempt can be made to establish a handshake connection to see whether the system responds. If handshake doesn't work, then request confirmation from the system of receipt of a message that was never actually sent because some servers can thereby be caused to give a negative response. If that doesn't work, then send a message confirming reception of a message from the server that was not actually received because some servers can thereby be caused to give a negative response. Tactics like these can generate a significant amount of information about the customer's network of systems 1002.

Based on that information, found in the initial mapping, the first wave 1410 of tools can be prepared and executed to find general problems. Most services have general problems that affect all versions of that service regardless of the vendor. For example, ftp suffers from anonymous access 1412, e-mail suffers from unauthorized mail relaying 1414, web suffers from various sample scripts 1416, etc. In addition, the first wave 1410 of tools 514 attempts to collect additional information related to the specific vendor that programmed the service. The information collected from the first wave 1410 can be analyzed and used to prepare and execute the next wave of tools 514. The second wave 1420 looks for security holes that are be related to specific vendors (for example, 1422, 1424, 1426, and 1428). In addition to any vendor specific vulnerabilities that are discovered, the second wave attempts to obtain the specific version numbers of the inspected services. Based on the version number, additional tools 514 and tests 516 can be prepared and executed for the third wave 1430. The third wave 1430 returns additional information like 1432, 1434, 1436, and 1438.

Software Scanner Logic

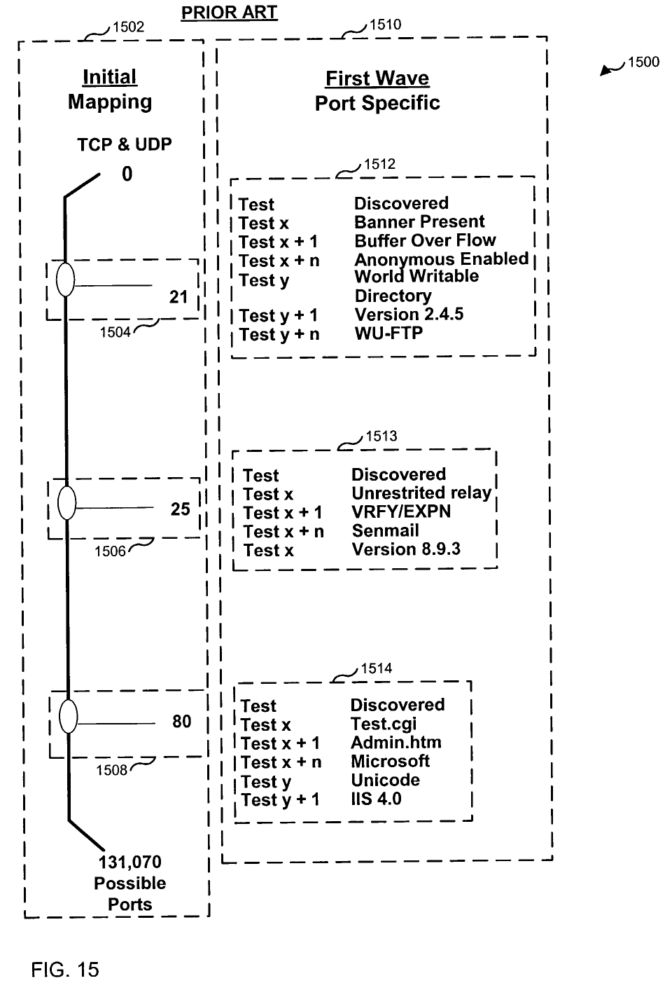

Depicted in overview 1500 of PRIOR ART FIG. 15 for comparison purposes, is the typical method of test that is found in vulnerability scanner software. It simply finds open service ports during an initial mapping 1502 and then executes all tests 516 pertaining to the “testing group” (for example, 1512, 1513, and 1514) in a first (and only) wave 1510. While it can gather similar vender/version information as it goes, it does not actually incorporate the information into the scan. This type of logic does not adapt its testing method to respond to the environment, making it prone to false positives. A false positive occurs when a vulnerability is said to exist based on testing results, when the vulnerability does not actually exist.

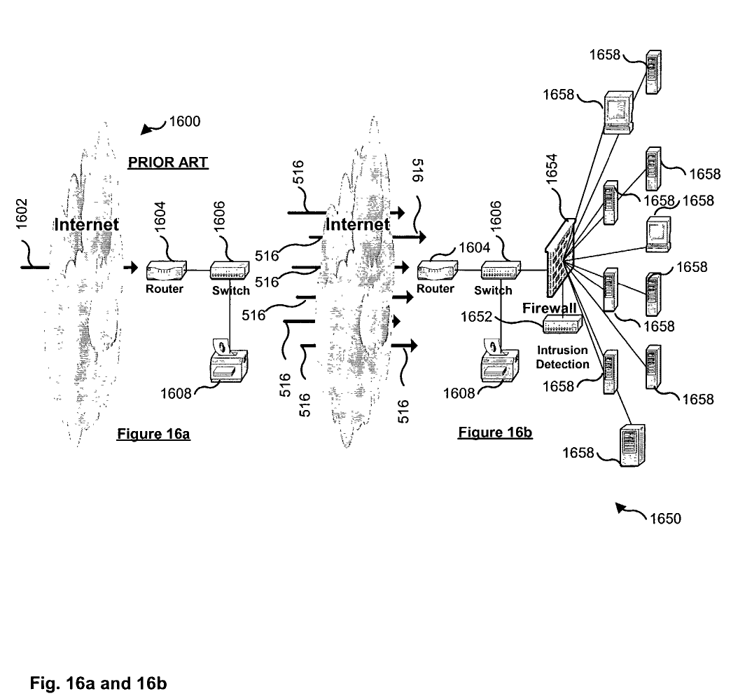

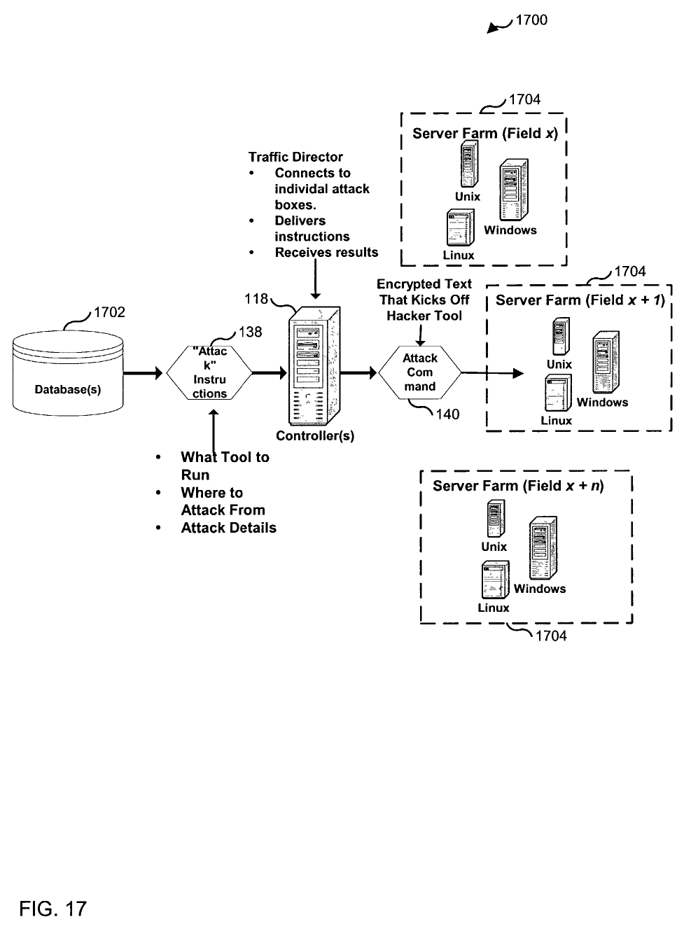

Software scanners can be blocked at the point of customer defense, as shown for example, in FIG. 16a, in overview 1600 of PRIOR ART FIG. 16a, where test 1602 finds devices 1604, 1606, an 1608 only. A preferred embodiment, by contrast, can penetrate those defenses to accurately locate all devices reachable from the Internet, in the example shown in overview 1600 of FIG. 16b, where tests 516 find devices 1604, 1606, 1608, and also, beyond defenses 1652 and 1654, devices 1658.

Note that there is no reason why an alternative communication medium other than the Internet could not be used by a preferred embodiment. Such would not constitute a substantial variance.

Better Test Methodologies Provide Better Results

A preferred embodiment, through distributed basic tests 516, is able to accurately map all of the networks 1002 and systems 1102 that are reachable from the Internet. The same distributed basic test methodology, in conjunction with pre- and post-testing, 508 enables a preferred embodiment to continue to evade IDS in order to accurately locate security vulnerabilities accurately on every machine 1102.

FIGS. 16a and 16b illustrate some differences between the capabilities of some PRIOR ART software scanners and a preferred embodiment. Typically, the greater the security measures in place, the greater the difference between these capabilities. The customer network being analyzed in the illustrations can be based on an actual system tested with a preferred embodiment, the network having very strong security defenses in place. The PRIOR ART testing of FIG. 16a was able to locate only a small portion of the actual network. By contrast, FIG. 16b depicts the level of discovery a preferred embodiment was able to achieve regarding the same network under test.

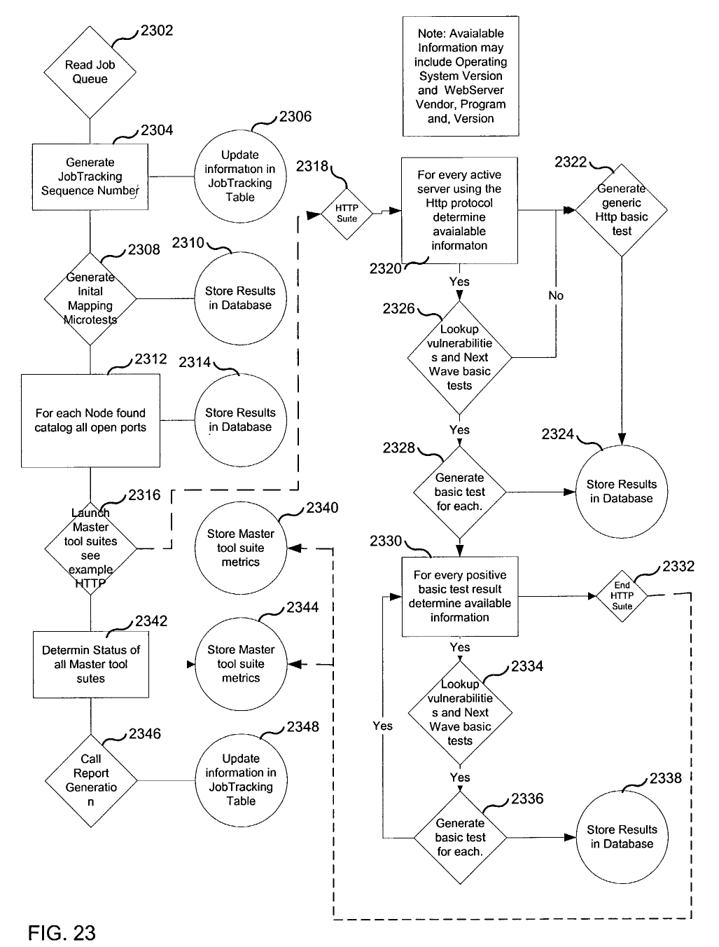

FIG. 23 depicts logic flow within the Command Engine. First, the job cue is read, 2302; a job tracking sequence number is generated, 2304; information in the job tracking table is updated, 2306; and initial mapping basic tests are generated, 2308. The results of the initial mapping is stored in the Database, 2310. All open ports are catalogued for each node, 2312, and the results of that cataloguing is stored in the Database, 2314. Master tools are then simultaneously launched for all ports and protocols that need to be tested, 2312. The example illustrated shows only one tool suite needing to be launched, that being the HTTP protocol that was found on the open port. Block 2318 represents the launching of the HTTP suite. If the system under test has given no information about itself, then a generic HTTP test is generated, 2322, and the results are stored in the Database, 2324. However, if information is available about the systems under test at step 2320, then vulnerabilities are looked up and the next wave of basic tests planned accordingly, 2326. Basic tests are generated for each vulnerability, 2328, and results are stored in the Database from each basic test, 2324. Each basic test will either return a positive or negative result. For each positive result, determine whether information is available, 2330. Once all available information has been gathered, the http suite will end, 2332. So long as additional available information exists, vulnerabilities are looked up, and the next wave of basic tests, as appropriate, are generated based on that available information, 2334. Basic tests are generated for each vulnerability, 2336. The results of those basic tests are stored in the Database, 2338. Then the cycle repeats itself with a determination of whether available information still exists, 2330. After the master suite is finished, 2332, metrics are stored, 2340. The metrics might describe, for example, how long tools were operated, when the tools were executed, when they finished executing, etc. The status of all master tool suites is determined, 2342, and following the completion of all master tool suites, the reports are generated accordingly, 2346. The information in the job tracking table is then updated to indicate that the job has been completed and to store any other information that needs to be tracked, 2348.

Further Discussion of Testing Methodology

In a preferred embodiment, multiples waves of testing occur with each subsequent wave of tests including tests that are more finely grained. That is, each subsequent wave of tests includes tests that are more specifically focused on the system under test based on information obtained as in prior test results. Thereby, the testing methodology is more efficient than a brute force effort to blindly test every part of the system under test for every possible vulnerability, even though many vulnerabilities are logically eliminated from possibly being present by the results of earlier testing.

A preferred embodiment handles two types of testing difficulties. In the first case, testing may be impossible or hindered by physical or network connection difficulties. That is, tester communications fail to reach the system under test. In the second case, tester communications are able to physically reach the system under test, but a logic connection cannot be established. This is typically caused by recognition of the tester as a cyber attacker by an Intrusion Detection System (IDS). Failure at this point is failure to establish the session component of communicable coupling.

The first case is handled by switching to a different tester, perhaps using a different physical connectivity service provider. Successful establishment of a connection by the different tester would indicate a likelihood that the failed connectivity was due to a physical connectivity problem rather than IDS recognition.

The second case is handled by switching to a different IP address and attempting to test again. The different IP address may be on the same tester or a different tester. Successful establishment of a connection using the different IP address with the same tester would indicate a likelihood of IDS of the test from the first IP address.

In a preferred embodiment, testing occurs in successive waves, each wave generating additional information about the system under test, confirming the presence or likely presence of certain vulnerabilities and logically eliminating the possibility of other vulnerabilities. This process does not gather an infinite amount of information about the system under test. Rather, it gathers as much information as is possible based on the tools contained in the arsenal.

In a preferred embodiment, an initial mapping consists of a wave of a few tests of differing protocols directed to each IP address of the system under test. This efficiently determines with high likelihood the accessibility of IP addresses. For example, if a target IP address was tested previously and determined to be active, but in the current initial mapping it is completely unresponsive to a few tests of differing protocols, then that IP address is not tested further during the currently scheduled test. If a target IP address is found to be open, then subsequent testing waves could, for example, extensively test every port of the IP address.

Many preferred embodiments utilize a customer profile in improving the efficiency and effectiveness of testing. In a preferred embodiment, the pre-test customer profile contains customer information, IP addresses, test tool constraints, test methodology restraints, and connectivity bandwidth of connections. Note that in other embodiments, customer profiles could contain more or less information of an extremely wide scope, and that would not depart from the scope of the present invention.

In a preferred embodiment, tests are distributed among testers to optimize speed, connectivity, and cost considerations. Other embodiments have other decision rules, not necessarily distributing for optimization, and not necessarily having the same factors. Examples of distribution considerations include size of the system under test, load on testers from other sources besides tests for the system under test, connectivity performance, cost for bandwidth factors, geographic proximity, known obstacles, etc. Examples of known obstacles include openings given through system defenses, firewall/filter information already known, active IDS information already known, etc. Examples of cost factors include cost per bit, cost per transmission, etc. Examples of connectivity performance include absolute speed, reliability, etc.

Operation of a Preferred Embodiment

The following is a description of an example of one preferred embodiment's operation flow.

Security assessment tests for each customer can be scheduled on a daily, weekly, monthly, quarterly or annual basis. The Job Scheduling module 202 initiates customer tests, at scheduled times, on a continuous basis.

The Check Schedule module 302 in the Command Engine 116 polls the Job Scheduling module 202 to see if a new test needs to be conducted. If a new test job is available, the Check Schedule module 302 sends the customer profile 204 to the Test Logic module 304. The customer profile 204 informs the Command Engine 116 of the services the customer purchased, the IP addresses that need to be tested, etc. so that the Command Engine 116 can conduct the appropriate set of tests 516.

Based on the customer profile 204, the Test Logic module 304 determines which tests 516 needs to be run by the Testers 502 and where the tests 516 should come from. The Test Logic module 304 uses the customer profile 204 to assemble a list of specific tests 516; it uses the Resource Management module 308, which tracks the availability of resources, to assign the tests 516 to specific Testers 502. This list can be sent to the Tool Initiation Sequencer 312. The Tool Initiation Sequencer 312 works in conjunction with the Tool Management module 314 to complete the final instructions to be used by the Gateway 118 and the Testers 502. These final instructions, the instruction sequences, can be placed in the Queue 310.

The Gateway 118 retrieves 402 the instruction sequences from the Queue 310. Each instruction sequence consists of two parts. The first part contains instructions to the Gateway 118 and indicates which Tester 502 the Gateway 118 should communicate with. The second part of the instructions is relevant to the Tester 502, and it is these instructions that are sent to the appropriate Tester 502.

Each port on each system 1102 is typically tested to find out which ports are open. Typically, there are 65,535 TCP ports and 65,535 UDP ports for a total of 131,070 ports per machine. For example, one hundred thirty tests can be required to determine how many of the ports are open. Certain services are conventionally found on certain ports. For example, web servers are usually found on port 80. However, a web server may be found on port 81. By checking protocols on each possible port, a preferred embodiment would discover the web server on port 81.

Once the test 516 is completed by the Tester 502, the results are received by the Tool/Test Output module 306. This module sends the raw results 214 to the Database 114 for storage and sends a copy of the result to the Test Logic module 304. The Test Logic module 304 analyzes the initial test results and, based on the results received, determines the make-up of the next wave of basic tests 516 to be performed by the Testers 502. Again, the new list is processed by the Tool Initiation Sequencer 312 and placed in the Queue 310 to be retrieved by the Gateway 118. This dynamic iterative process repeats and adapts itself to the customer's security obstacles, system configuration and size. Each successive wave of basic tests 516 collects increasingly detailed information about the customer system 1102. The process ends when all relevant information has been collected about the customer system 1102.

As tests 516 are being conducted by the system, performance metrics 208 of each test are stored for later use.

The Resource Management module 308 helps the Test Logic 304 and the Tool Initiation modules 312 by tracking the availability of Testers 502 to conduct tests 516, the tools 514 in use on the Testers 502, the multiple tests 516 being conducted for a single customer network 1002 and the tests conducted for multiple customer networks 1002 at the same time. This can represent hundreds of thousands of basic tests 516 from multiple geographical locations for one customer network 1002 or several millions of basic tests 516 conducted at the same time if multiple customer networks 1002 are being tested simultaneously.

The Gateway 118 is the “traffic director” that passes the particular basic test instructions from the Command Engine Queue 310 to the appropriate Tester 502. Each part of a test 516 can be passed as a separate command to the Tester 516 using the instructions generated by the Tool Initiation Sequencer 312. Before sending the test instructions to the Testers 502, the Gateway 118 verifies that the Tester's 502 resources are available to be used for the current test 516. Different parts of an entire test can be conducted by multiple Testers 502 to randomize the points of origin. This type of security vulnerability assessment is typically hard to detect, appears realistic to the security system, and may reduce the likelihood of the customer security system discovering that it is being penetrated. Multiple tests 516, for multiple customer systems 1102 or a single customer system 1102, can be run by one Tester 502 simultaneously. Typically, all communication between the Gateway 118 and the Testers 502 is encrypted. As the results of the tests 516 are received by the Gateway 118 from the Testers 502 they are passed to the Command Engine 116.

The Testers 502 house the arsenals of tools 514 that can conduct hundreds of thousands of hacker and security tests 516. The Tester 502 receives from the Gateway 118, via the Internet, encrypted basic test instructions. The instructions inform the Tester 502 which test 516 to run, how to run it, what to collect from the customer system, etc. Every basic test 516 is an autonomous entity that is responsible for only one piece of the entire test that can be conducted by multiple Testers 502 in multiple waves from multiple locations. Each Tester 502 can have many basic tests 516 in operation simultaneously. The information collected in connection with each test 516 about the customer systems 1102 in customer network 1002 is sent to the Gateway 118.

The API 512 is a standardized shell that holds any code that is unique to the tool (such as parsing instructions), and thus APIs commonly vary among different tools.

Report Generator Subsystem Functionality

The Report Generator 110 uses the information collected in the Database 114 about the customer's systems 1002 to generate a report 2230 about the systems profile, ports utilization, security vulnerabilities, etc. The reports 2230 reflect the profile of security services and reports frequency the customer bought. Security trend analyses can be provided since the scan stores customer security information on a periodic basis. The security vulnerability assessment test can be provided on a monthly, weekly, daily, or other periodic or aperiodic basis specified and the report can be provided in hard copy, electronic mail or on a CD.

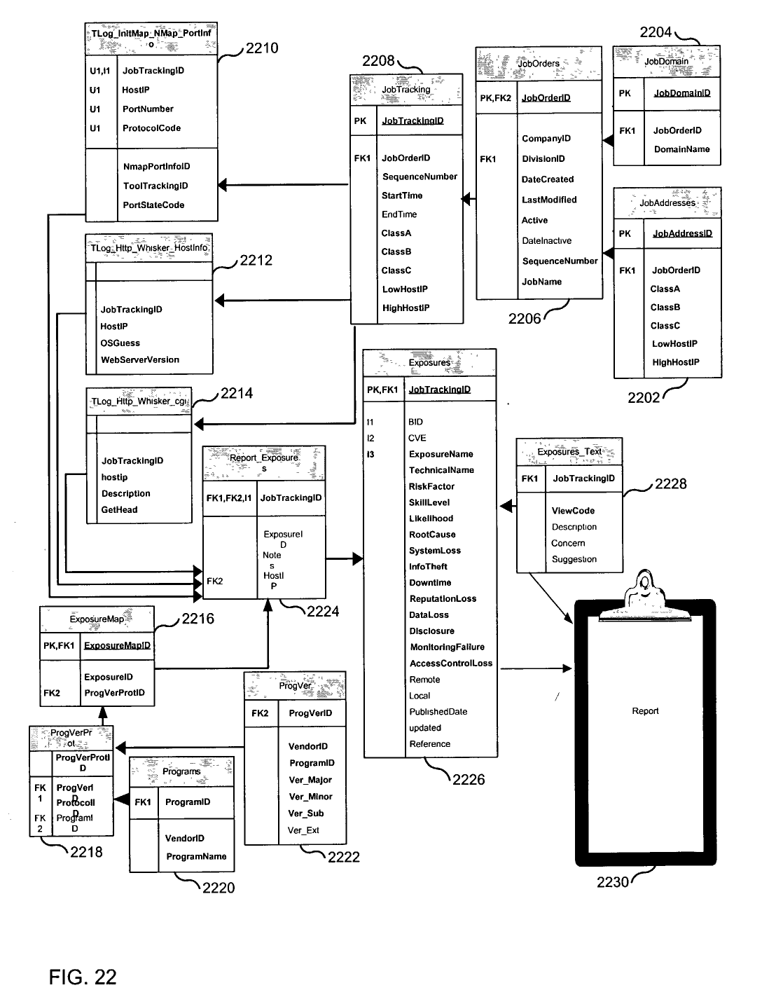

FIG. 22 depicts the logic flow at a high level of information flowing through a preferred embodiment during its operation. The domain or URL and IP addresses of the system to be tested are provided in Table 2202 and 2204 combining to make up a job order shown as Table 2206. Job tracking occurs as described elsewhere in the specification represented by Table 2208. Tables 2210, 2212, and 2214 depict tools being used to test the system under test. Information is provided from those tools following each test and accumulated as represented in Table 2224 in the Database 114. Additional information about vulnerabilities is gathered from other sources other than through test results as represented by Tables 2222, 2220, 2218 and 2216, which is also fed into Table 2224. Therefore, Table 2224 should contain information on the vulnerabilities mapped to the IP addresses for that particular job. Tables 2226 and 2228 represent the vulnerability library, and information goes from there to create Report 2230.

Future reports/reporting capabilities might include, survey details such as additional information that focuses on the results of the initial mapping giving in depth information on the availability and the types of communication available to machines that are accessible from the Internet; additional vulnerability classifications and breakdowns by those classifications; graphical maps of the network; new devices since the previous assessment; differences between assessments: both what is new and what has been fixed since the previous assessment; IT management reports, such as who has been assigned the vulnerability to fix, who fixed the vulnerability, how long has the vulnerability been open and open vulnerabilities by assignment, and breakdown of effectiveness of personal at resolving security issues.

Early Warning Generator Subsystem Functionality

On a regular basis (up to daily), new vulnerabilities are found on hacker sites, manufacturer sites, security organization sites, etc. Those vulnerabilities are also referred to herein as “generic vulnerability data”.

The Early Warning Generator subsystem 112 can be used to alert relevant customers on a daily basis of new security vulnerabilities that can affect their system 1102 or network 1002. On a daily basis, when new security vulnerabilities can be provided, a preferred embodiment compares 710 the new vulnerability 702 against the customer's most recent network configuration profile 708. If the new vulnerability 702 can be found to affect the customer systems 1102 or network 1002 then an alert 714 is sent via e-mail 712 to the customer. The alert 714 indicates the detail of the new vulnerability 702, which machines are affected, and what to do to correct the problem. Only customers affected by the new security vulnerabilities 702 receive the alerts 714.

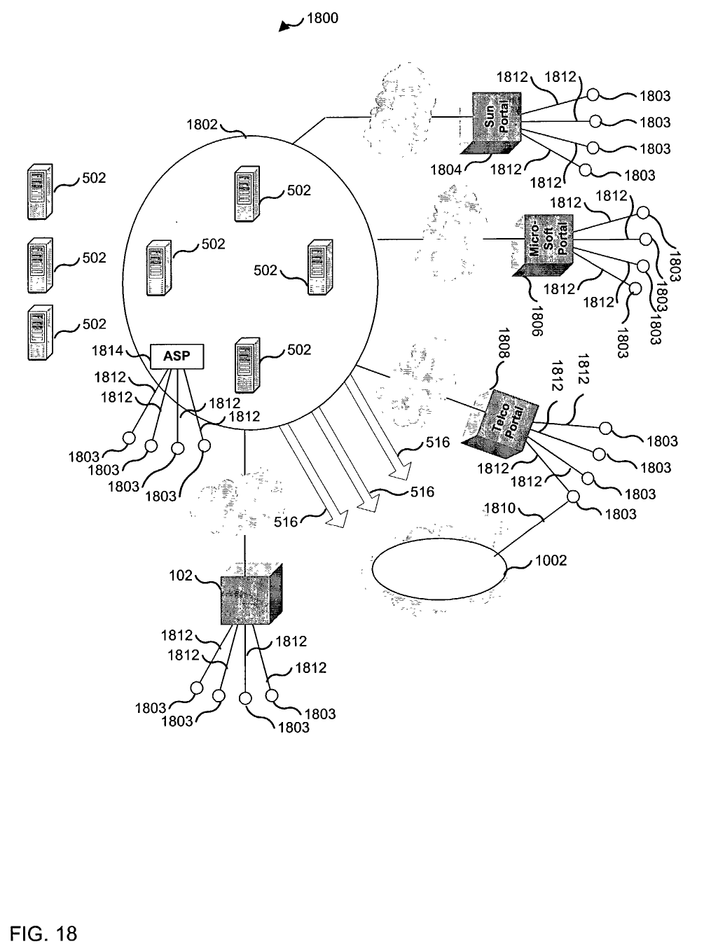

FIG. 18 shows an alternative preferred embodiment in which third-party portals 1804, 1806, and 1808, for example, access the services of the system. Tester 502 contained within logical partition 1802 have been selected to provide services accessible via portals 1804, 1806, and 1808. Tester's 502 outside of logical partition 1802 have not been selected to provide such services. ASP 1814 has been connected as part of the logical system 1802 in order to provide services directly from the set of Tester's 502 contained within logical system 1802. The Tester's 502 contained within logical system 1802 is driven by Test Center 102. Requests for testing services are initiated from customer node 1803 through communication connection 1812. Requests for services can be initiated directly from a customer node 1803 to Test Center 102; or through a third-party portal, such as one of portals 1804, 1806 or 1808; or directly to a linked ASP 1814. The communication link from any particular customer node 1803 is shown by communication link 1812 and can be any communication technology, such as DSL, cable modem, etc. The ASP is linked to logical system 1802 by using logical system 1802 to host itself to deliver services directly to its customers. In response to service requests, Tester's 502 within logical system 1802 are used to deliver tests 516 on the designated IP addresses which make up customer network 1002. Customer network 1002 can or cannot be connected to the requesting customer node 1803 via possible communication link 1810. Note that logical system 1802 can alternatively include all Tester's 502.

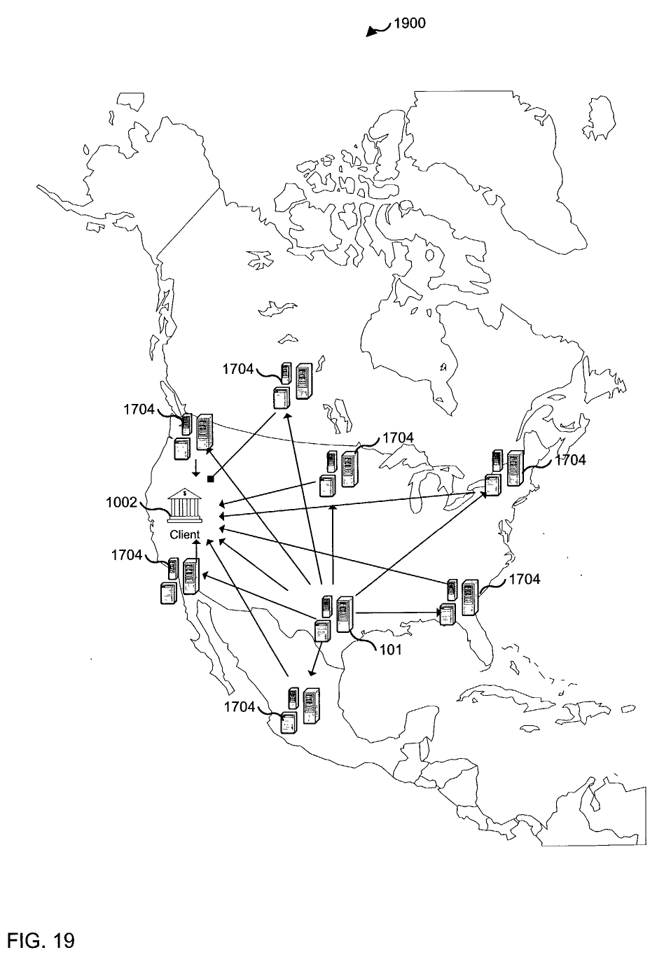

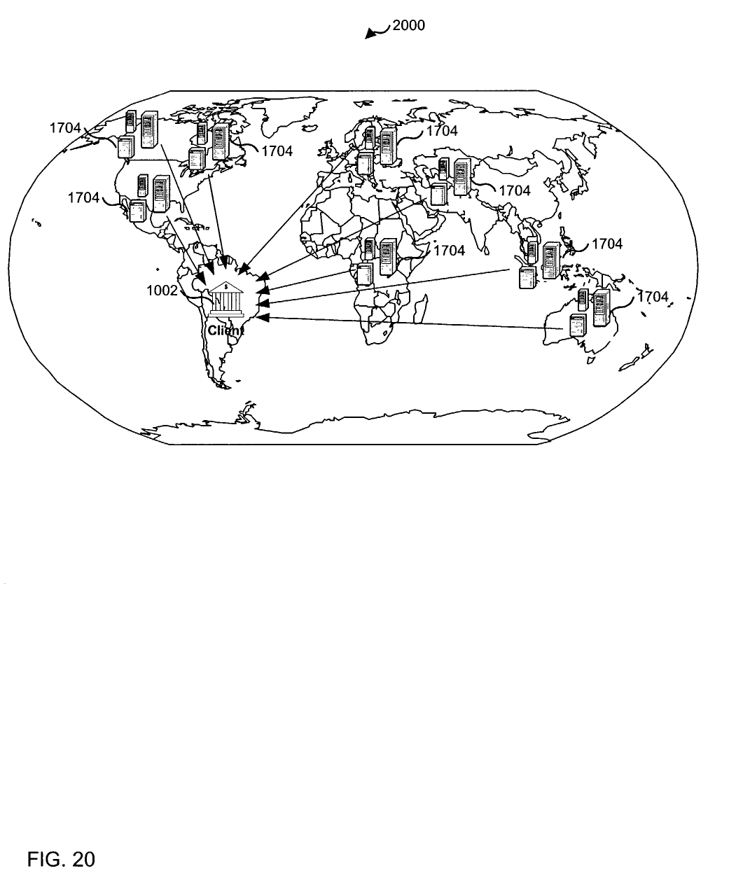

Geographic overview diagram 1900 in FIG. 19 depicts a geographically disbursed array of server farms 1704 conducting tests on client network 1002 as orchestrated by Test Center 101. Similarly, geographic overview 2000 in FIG. 20 shows the testing of customer network 1002 by a geographically disbursed array of Tester farms 1704.

Communications described as being transmitted via the Internet may be transmitted, in the alternative, via any equivalent transmission technology, such as direct connection, local area network communication, etc. Also, there is no reason why the functionalities of the Test Center 101 cannot be combined into a single computing device. Similarly, there is no reason why the functionalities of Test Center 102 cannot be combined into a single computing device. Such combinations, or partial combinations in the same spirit are within the scope of the invention and would not be substantially different from a preferred embodiments. Similarly, in most discussions of exemplary embodiments discussed in this specification, Test Center 101 and Test Center 102 would be interchangeable without affecting the spirit of the embodiment being discussed. A notable exception, for example, would be the discussion of updating tools 514, in which Test Center 101 is appropriately used because of the need for the functionality of RMCTs 119. Reports are described in this specification as being in any of a variety of formats. Additional possible formats include .doc, .pdf, html, postscript, .xml, test, hardbound, CD, flash, or any other format for communicating information.

Active Vulnerabilities

Vulnerabilities typically, but not necessarily, pass through a vulnerability life cycle over time. Such a vulnerability life cycle may last days, weeks, or longer. A graph of the vulnerability life cycle would typically graph the activity level of tests exploiting a given vulnerability against time. The shape of such a graph would typically be somewhat bell-shaped. The activity level of a test, among computers connected to the Internet for example, would typically be low at first, then higher as it becomes more widely known among cyber-hackers, and then low again as its popularity declines. Typically a surge in popularity occurs when a test is new, but there may be other reasons for an increase in popularity.

For example, a company with a computer network having several vulnerabilities would benefit by awareness that one of the vulnerabilities currently has a high activity level while the other vulnerabilities have low activity levels. Such awareness can be provided if the company is given a report earlier than the report generated based on the next periodically occurring test.

An attack is analogous to an unauthorized test. Each attack may leave evidence that it has been executed—one or more footprints. Various collective devices, such as firewalls and intrusion detection systems, collect such footprints. For example, a review of a firewall log could reveal a footprint, making it likely that the attack corresponding to that footprint had targeted that firewall. Reviewing a sample of footprints, or lack thereof, from a set of collective devices would allow an estimate to be made of the activity level of the corresponding attack across the Internet. Computing devices could be intentionally connected to the Internet to acquire such a sample.

The collective devices can be specialized for the purpose of gathering footprint and/or related information. They could undertake a heavy analysis of passing information.

Activity level may be defined many different ways, including none, some, or all of the following factors: type of attacks attempted, number of attempts during a given time period for each attack, type of attack successful, number of successes during a given time period for each attack, relative and/or absolute targeting of computers operating within a defined commercial sector, etc.

An Example of Using Raw Data Other than from Testing

In a preferred embodiment, raw test information would come from the customer would provide raw data instead of raw test information. The difference being that the raw data could result from testing, but need not. In this example, a fictitious company called Computers, Inc. (CI) would like to manage vulnerabilities associated with its telephone system. The company first performs a telephone sweep of voice mail, facsimile, and modem numbers to generate raw test information on vulnerabilities. The raw test information is stored in a database. In this case the telephone sweep is analogous to the testing of a system under test. The raw test information is then processed and reports are generated as in other embodiments.

Another example of such reporting could be helpful to the wireless telephone industry in testing its local wireless infrastructure.

Additional Points

It is apparent that the report generator is language-neutral. That is, the language(s) in which the report modules are written are determinative of the language(s) of the reports. Examples of languages include English, technical, layman's terms, senior executive's, etc.

Reference is made throughout this specification to reporting and communication of information. The format of such information is not typically crucial to the spirit, concept, or enablement of this invention. For example, reports can be transmitted in nearly any format, including XLS, DOC (MS Word), PDF, XML, HTML, etc. Such reports can be transmitted by virtually any means without departing from the scope of the present invention. Examples of transmission means include ZIP, encrypted e-mail, PGP, SMIME, public key, etc.

The term “communicably coupled” refers to any connection that is adapted to carry communication, whatever the supporting technology. It includes hard wire connections such as phone lines, Ti lines, DSL, fiber optic, Ethernet, twisted pair, etc. It also includes wireless connections adapted to carry communication such as via electromagnetic waves, wireless optics (e.g., infrared), etc. Further, the term includes logical connections between two processes on the same system and processes connected by a common computing device memory space. The technology by which the communication is transmitted is not material to the meaning of communicably coupled.

The term “computing device” includes a device having at least one central processing unit (CPU) and a memory device, wherein the CPU is adapted to process data that can be stored in the memory device before and/or after processing. Common examples of a computing device include personal computer, palm computing device, notebook computer, server, or mainframe. Also included within the definition of computing device is a system of multiple computers networked together such that processing and/or storage activities on the computers are coordinated. Also included in the definition of computing device is a system of devices networked together such that each device may not be a computer in its own right, but in combination, the networked devices achieve the functionality of a computer having at least one CPU and at least one memory device. For example, components of a computing device may be connected across the Internet.

The term “memory device” includes all data storage devices, including non-volatile, volatile, and other data storage devices.

The term “non-volatile storage” includes storage devices whose contents are preserved when their power is off. These devices are often used as secondary storage devices. Storage using magnetic media (e.g. magnetic disks, magnetic tape or bubble memory) is normally non-volatile by nature. Other examples of non-volatile storage include Bernoulli Box (trademark of Iomega Corporation), compact disc (CD), computer output on microfilm (COM), computer output on laser disk (COLD), digital audio tape (DAT), digital linear tape (DLT), digital versatile disk (DVD), electrically alterable programmable read-only memory (EAPROM), electrically erasable programmable read-only memory (EEPROM), erasable programmable read-only memory (EPROM), flash erasable programmable read-only memory (FEPROM), floppy disk, floptical, hard disk (removable or fixed), Jaz Drive (trademark of lomega Corporation), JBOD, disk farm, magnetic disk, magnetic drum, optical disk, magneto-optical disk, one time programmable read-only memory (OTPROM or OTP), programmable read-only memory (PROM), tape drive, paper tape, and punch cards.

The term “volatile storage” includes storage devices whose contents are not ordinarily preserved when their power is off. Examples of volatile memory include semiconductor memories (static RAM and especially dynamic RAM), which are normally volatile but can be made into non-volatile storage by having a (rechargeable) battery or other uninterrupted power supply permanently connected. Dynamic RAM is particularly volatile since it loses its data, even if the power is still on, unless it is refreshed. An acoustic delay line is a (very old) example of a volatile storage device.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. In particular, none of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Thus, it is intended that the following claims be interpreted to embrace all such further modifications, changes, rearrangements, substitutions, alternatives, design choices, and embodiments. Moreover, none of these claims are intended to invoke paragraph six of 35 U.S.C. §112 unless a phrase of the particular style “means . . . for” is followed by a participle.

What is claimed is:

1. A method of generating a report comprising:
receiving raw data, wherein the raw data comprises test results;
storing the raw data;
determining a plurality of raw vulnerabilities based on the raw data;
selecting, based on a report recipient, a plurality of selected vulnerabilities, wherein each of the plurality of selected vulnerabilities is contained in the set of the plurality of raw vulnerabilities;
selecting, for each of the plurality of selected vulnerabilities, a selected report element, wherein each selected report element is selected, based on the report recipient, from a plurality of report elements that corresponds to the selected vulnerability;
wherein the selected report elements are included in a report; and
transmitting the report to the report recipient.

2. The method of claim 1, wherein the selected report elements comprise key indicators, whereby the report comprises a key indicator report.

3. The method of claim 1, wherein the selected report elements comprise standard report elements, whereby the report comprises a standard report.

4. The method of claim 1,
wherein the selected report elements comprise technical report elements;
wherein the selected report elements are included in the report in a fashion organized by IP address; and
whereby the report comprises a technical summary by IP address report.

5. The method of claim 1,
wherein the selected report elements comprise technical report elements;
wherein the selected report elements are included in the report in a fashion organized by host; and
whereby the report comprises a by host report.

6. The method of claim 1, wherein the selected report elements comprise corrective instructions, whereby the report comprises an action report.

7. The method of claim 1, wherein said receiving raw data comprises receiving raw data from a tester, the method further comprising:
prior to receiving raw data from the tester, testing by a tester of a system under test while the system under test operates normally; and
wherein said testing produces the raw data.

8. The method of claim 7, wherein one of the plurality of raw vulnerabilities comprises a positive test vulnerability based on at least some of said testing.

9. The method of claim 7,
wherein the raw data comprises configuration data of the system under test; and
wherein one of the plurality of raw vulnerabilities comprises a positive configuration vulnerability based on at least some of the configuration data.

10. The method of claim 7,
wherein the raw data comprises configuration data of the system under test; and
wherein one of the plurality of raw vulnerabilities comprises a warning configuration vulnerability based on at least some of the configuration data.

11. The method of claim 7,
wherein the raw data comprises configuration data of the system under test; and
wherein one of the plurality of raw vulnerabilities comprises a warning best practices vulnerability based on at least some of the configuration data.

12. The method of claim 7, further comprising:
generating profile change data based on comparison of the raw data and existing data.
wherein one of the plurality of raw vulnerabilities comprises a warning profile change vulnerability based on at least some of the profile change data.

13. The method of claim 1, wherein the raw data comprises telephone sweep data.

14. The method of claim 1, further comprising:
selecting, based on at least one additional report recipient, at least one additional plurality of selected vulnerabilities, such that each plurality of selected vulnerabilities corresponds to one of the report recipients, and such that each of the pluralities of selected vulnerabilities is contained in the set of the plurality of raw vulnerabilities;
selecting, for each of the additional plurality of selected vulnerabilities, an additional selected report element, wherein each additional selected report element is selected, based on the corresponding additional report recipient, from an additional plurality of report elements that corresponds to the additional selected vulnerability;
wherein, for each additional plurality of selected vulnerabilities, each of the additional selected report elements are included in an additional report;
whereby each report is adapted based on its report recipient.

15. The method of claim 1, wherein said transmitting the report to the report recipient comprises e-mailing the report to the report recipient.

16. The method of claim 1, wherein said transmitting the report to the report recipient comprises directly transferring the report into an enterprise level system of the report recipient.

17. A method of generating a report comprising:
receiving generic vulnerability data;
determining a plurality of raw vulnerabilities based on comparison of the generic vulnerability data with stored raw data, wherein the stored raw data comprise test results;
selecting, based on a report recipient, a plurality of selected vulnerabilities, wherein each of the plurality of selected vulnerabilities is contained in the set of the plurality of raw vulnerabilities;
selecting, for each of the plurality of selected vulnerabilities, a selected report element, wherein each selected report element is selected, based on the report recipient, from a plurality of report elements that corresponds to the selected vulnerability;
wherein the selected report elements are included in a report; and
transmitting the report to the report recipient.

18. A method of generating a report comprising:
at least one iteration of the method of claim 17, each having a corresponding plurality of raw vulnerabilities;
wherein the stored raw data comprise data generated by prior tests of a system under test;
testing the system under test;
receiving new raw data, wherein the new raw data comprise test results;
storing the new raw data;
determining a plurality of new raw vulnerabilities based on the new raw data;
comparing the new raw vulnerabilities to the raw vulnerabilities of the pluralities of raw vulnerabilities to ascertain corrected vulnerabilities comprising the raw vulnerabilities of the pluralities of raw vulnerabilities that are not among the new raw vulnerabilities;
selecting selected report elements based on the corrected vulnerabilities;
wherein the selected report elements are included in a report; and
transmitting the report to the report recipient.

19. The method of claim 18, further comprising
comparing the new raw vulnerabilities to the raw vulnerabilities of the pluralities of raw vulnerabilities to ascertain uncorrected vulnerabilities comprising the raw vulnerabilities of the pluralities of raw vulnerabilities that are among the new raw vulnerabilities; and
selecting selected report elements based on the uncorrected vulnerabilities.

20. The method of claim 19, further comprising:
formulating metrics describing characteristics of the corrected vulnerabilities;
wherein characteristics each of the corrected vulnerabilities include:
duration of time from the time that a report was transmitted with at least one report element corresponding to the now corrected vulnerability until the now corrected vulnerability was first determined to be corrected; and
percentage of the raw vulnerabilities of the pluralities of raw vulnerabilities that became corrected vulnerabilities;
formulating metrics describing characteristics of the uncorrected vulnerabilities; and
wherein characteristics each of the uncorrected vulnerabilities include:
duration of time from the time that a report was transmitted with at least one report element corresponding to the uncorrected vulnerability until the uncorrected vulnerability was last determined to be uncorrected; and
percentage of the raw vulnerabilities of the pluralities of raw vulnerabilities that are uncorrected vulnerabilities.

21. The method of claim 20, further comprising comparing the metrics of one company with metrics of companies in the same industry.

22. A method of generating a report comprising:
specifying an attack;
ascertaining an attack footprint, wherein detection of the attack footprint by a collective device indicates at least a likelihood that the attack has been executed;
estimating an activity level for the attack among computing devices connected to a network based on prevalence of attack footprints on the network;
creating a report including the estimated activity level for the specified attack;
transmitting the report to a report recipient, wherein the system of the report recipient is vulnerable to the specified attack.

23. The method of claim 22, wherein the activity level for a specified attack among computing devices connected to the Internet includes frequency of attempts and frequency of successes for the specified attack.

24. The method of claim 22, wherein the activity level for a specified attack among computing devices connected to the Internet is based at least partially on analysis of information obtained via collective devices.
